(19) United States
(12) Patent Application Publication
(10) Pub. No.: US 2026/0230742 A1
(43) Pub. Date: Aug. 6, 2026

(54) EARPHONES

(71) Applicant: SHENZHEN SHOKZ CO., LTD., Shenzhen (CN)

(72) Inventors: Burui GUO, Shenzhen (CN); Zhiqing LIU CHUN, Shenzhen (CN)

(73) Assignee: SHENZHEN SHOKZ CO., LTD., Shenzhen (CN)

(21) Appl. No.: 19/636,903

(22) Filed: Apr. 1, 2026

Related U.S. Application Data
(63) Continuation of application No. PCT/CN2025/092640, filed on Apr. 30, 2025.

(30) Foreign Application Priority Data
Dec. 15, 2024 (CN) 202411844133.7

(51) Int. Cl. H04R 1/10; H04R 1/06

(52) U.S. Cl. CPC H04R 1/1066; H04R 1/06; H04R 1/1016; H04R 1/105; H04R 1/1075

(57) ABSTRACT

Disclosed is an earphone. The earphone includes an end cap portion, a housing portion, an adapter portion, an ear hook portion, and a loudspeaker. The end cap portion, the housing portion, and the adapter portion are connected in sequence to form a three-section structure. In the three-section structure, two sides of the housing portion are provided with a first opening and a second opening, respectively. The end cap portion covers the first opening, and the adapter portion covers the second opening. The housing portion forms a cylindrical structure with openings at two ends. The end cap portion, the housing portion, and the adapter portion can be quickly assembled along a major axis direction.

### CROSS-REFERENCE TO RELATED APPLICATIONS

This application is a continuation of International Patent Application No. PCT/CN2025/092640, filed on April 30, 2025, which claims priority to Chinese Patent Application No. 202411844133.7, filed on December 15, 2024, the entire contents of each of which are hereby incorporated by reference.

### TECHNICAL FIELD

The present disclosure relates to the field of acoustic technology, and in particular to an earphone.

### BACKGROUND

Earphones have become an indispensable tool in people’s daily lives and work. They can be used with mobile phones, computers, and other terminal devices to provide users with an auditory feast. How to rationally design the earphone structure to reduce assembly difficulty and improve assembly efficiency is a very important part of earphone structural design.

### SUMMARY

One or more embodiments of the present disclosure provide an earphone, which aims to reduce assembly difficulty and improve assembly efficiency of the earphone.

One or more embodiments of the present disclosure provide an earphone. The earphone comprises an end cap portion, a housing portion, an adapter portion, an ear hook portion, and a loudspeaker. The end cap portion, the housing portion, and the adapter portion are connected in sequence along a major axis direction. The ear hook portion is connected to an end of the adapter portion away from the housing portion. The housing portion is provided with an accommodation cavity. The loudspeaker is at least partially disposed in the accommodation cavity. An end of the housing portion along the major axis direction is provided with a first opening in communication with the accommodation cavity. The other end of the housing portion along the major axis direction is provided with a second opening in communication with the accommodation cavity. The end cap portion covers the first opening and is connected to the housing portion. The adapter portion covers the second opening and is connected to the housing portion. The major axis direction is not parallel to a vibration direction of the loudspeaker.

In some embodiments, at least one of the first opening or the second opening is configured to allow the loudspeaker to be inserted into the accommodation cavity, and an opening area of the at least one of the first opening or the second opening is greater than a maximum cross-sectional area of the loudspeaker in a cross section taken parallel to the vibration direction of the loudspeaker.

In some embodiments, the major axis direction is perpendicular to the vibration direction of the loudspeaker.

In some embodiments, the housing portion has a thickness direction perpendicular to the major axis direction, and the vibration direction is parallel to the thickness direction. In a wearing state of the earphone, the housing portion includes an inner wall facing an ear, an outer wall away from the ear, an upper wall facing upward, and a lower wall facing downward. The outer wall, the upper wall, the inner wall, and the lower wall are connected in sequence to enclose the accommodation cavity. The inner wall and the outer wall are located on two sides of the housing portion in the thickness direction, respectively. The vibration direction of the loudspeaker faces the inner wall.

In some embodiments, at least the inner wall is provided with a first through hole penetrating through the inner wall, and the first through hole is acoustically connected to the loudspeaker.

In some embodiments, the outer wall is provided with a second through hole penetrating through the outer wall.

In some embodiments, the earphone further comprises a loudspeaker bracket. The loudspeaker bracket is disposed in the accommodation cavity, and the loudspeaker is connected to the loudspeaker bracket. At least one of the first opening or the second opening is configured to allow the loudspeaker and the loudspeaker bracket to be inserted into the accommodation cavity together.

In some embodiments, a first limiting portion is disposed in the accommodation cavity, a second limiting portion is disposed on the loudspeaker bracket, and the first limiting portion and the second limiting portion are adaptively connected to fix the loudspeaker bracket in the accommodation cavity.

In some embodiments, the accommodation cavity is provided with a first guide portion extending along the major axis direction, the loudspeaker bracket is provided with a second guide portion, and the first guide portion and the second guide portion are adaptively connected to guide the loudspeaker bracket to be inserted into the accommodation cavity.

In some embodiments, the earphone further comprises a flexible circuit board. The flexible circuit board is electrically connected to the loudspeaker and fixed to the loudspeaker bracket.

In some embodiments, the adapter portion includes an adapter inner shell, an end of the adapter inner shell close to the housing portion includes an insertion portion, and the insertion portion is inserted into the second opening and connected to the housing portion.

In some embodiments, the adapter portion further includes an adapter outer shell, the adapter outer shell is configured to enclose an outer side of the adapter inner shell, and the end of the adapter inner shell close to the housing portion protrudes from the adapter outer shell to form the insertion portion.

In some embodiments, a third limiting portion is disposed at a position in the housing portion close to the second opening, a fourth limiting portion is disposed on the insertion portion, and the third limiting portion and the fourth limiting portion are adaptively connected to fix the insertion portion in the housing portion.

In some embodiments, an outer circumferential side surface of the insertion portion is provided with an adhesive groove. The adhesive groove is filled with an adhesive material for bonding the housing portion and the insertion portion.

In some embodiments, an end surface of the housing portion provided with the second opening is a first inclined surface, and the first inclined surface is inclined relative to a cross section taken parallel to the vibration direction of the loudspeaker. An end surface of the adapter outer shell close to the housing portion is a second inclined surface, and the second inclined surface is inclined relative to the cross section taken parallel to the vibration direction of the loudspeaker. The first inclined surface and the second inclined surface abut against each other.

In some embodiments, an end portion of the adapter outer shell provided with the second inclined surface at least partially extends above the adhesive groove.

In some embodiments, the end portion of the adapter outer shell extending above the adhesive groove at least partially protrudes toward the adapter inner shell and extends into the adhesive groove.

In some embodiments, at least a portion of the housing portion extends toward the adapter portion along the major axis direction to form a convex portion, the adapter outer shell is provided with a concave portion complementary to the convex portion, the insertion portion is provided with an exposed region formed by avoidance of the concave portion, and the adhesive groove is located in the exposed region.

In some embodiments, the housing portion has an integral structure or a split structure made of a metal or plastic material; and/or the end cap portion includes a contact layer made of a silicone or rubber material, a Shore hardness of the contact layer is less than a Shore hardness of the housing portion, and at least a portion of the contact layer abuts against a cavum conchae wall in a wearing state of the earphone.

In some embodiments, the adapter portion and the ear hook portion have an integral structure.

According to the earphone provided by the embodiments of the present disclosure, the earphone includes the end cap portion, the housing portion, the adapter portion, the ear hook portion, and the loudspeaker. The end cap portion, the housing portion, and the adapter portion are connected in sequence to form a three-section structure. In this three-section structure, the two sides of the housing portion are provided with the first opening and the second opening, respectively, the end cap portion covers the first opening, and the adapter portion covers the second opening. The end cap portion, the housing portion, and the adapter portion can be quickly assembled along the major axis direction. The housing portion forms a cylindrical structure with openings at two ends, which facilitates the mounting of internal components. The three-section structure of the earphone simplifies the mounting of the end cap portion, the housing portion, the adapter portion, and the loudspeaker, thereby improving the assembly efficiency of the earphone.

The three-section structure of the earphone facilitates the mounting stability of the loudspeaker. The outer wall of the loudspeaker can directly abut against the inner wall of the housing portion, and the cylindrical housing portion can restrain, wrap, limit, and fix the loudspeaker, thereby improving the mounting stability of the loudspeaker.

The earphone of the three-section structure consists of the end cap portion, the housing portion, and the adapter portion, which are connected in sequence along the major axis direction of the housing portion. The major axis direction is not parallel to the vibration direction of the loudspeaker. This design allows the openings at the two ends of the housing portion to be staggered from the through holes on different surfaces of the housing portion, preventing structural obstruction or interference with sound output effect at the connections between the housing portion and the end cap portion and adapter portion.

The three-section structure of the earphone can create a more aesthetically pleasing shape. The housing portion can be made into an integral structure, and the outer surface of the cylindrical housing portion can be smooth and seamless, which is more beautiful. In particular, when the outer surface of the housing portion is painted, a complete pattern can be formed.

### BRIEF DESCRIPTION OF THE DRAWINGS

FIG. 1 is a schematic structural diagram illustrating a human ear according to some embodiments of the present disclosure;

FIG. 2 is a schematic structural diagram illustrating an earphone in a wearing state according to some embodiments of the present disclosure;

FIG. 3 is a schematic structural diagram illustrating an outer side of an earphone according to some embodiments of the present disclosure;

FIG. 4 is a schematic structural diagram illustrating an inner side of an earphone according to some embodiments of the present disclosure;

FIG. 5 is a schematic structural diagram illustrating a housing portion and a loudspeaker of an earphone being separated along a major axis direction according to some embodiments of the present disclosure;

FIG. 6 is a cross-sectional view of a vertical plane of a housing portion of an earphone along a major axis direction according to some embodiments of the present disclosure;

FIG. 7 is a schematic structural diagram illustrating an end cap portion of an earphone according to some embodiments of the present disclosure;

FIG. 8 is a schematic structural diagram illustrating an end cap portion of an earphone according to some embodiments of the present disclosure;

FIG. 9 is a cross-sectional view of a vertical plane of a housing portion of an earphone along a major axis direction according to some embodiments of the present disclosure;

FIG. 10 is a cross-sectional view of a vertical plane of a connection between a housing portion and an adapter portion of an earphone along a major axis direction according to some embodiments of the present disclosure;

FIG. 11 is a schematic structural diagram illustrating a housing portion and an adapter portion of an earphone being separated along a major axis direction according to some embodiments of the present disclosure;

FIG. 12 is a schematic structural diagram illustrating an adapter portion of an earphone according to some embodiments of the present disclosure;

FIG. 13 is an exploded structural diagram illustrating an adapter outer shell and an adapter inner shell of an earphone according to some embodiments of the present disclosure;

FIG. 14 is a cross-sectional view of a vertical plane of a connection between a housing portion and an adapter portion of an earphone along a major axis direction according to some embodiments of the present disclosure; and

FIG. 15 is a schematic structural diagram illustrating a separator of an earphone according to some embodiments of the present disclosure.

### Reference signs in the figures:

101-external ear canal, 102-cavum conchae, 103-cymba conchae, 104-triangular fossa, 105-antihelix, 106-scaphoid fossa, 107-helix, 108-earlobe, 109-crus of helix, P1-first region, P2-second region, P3-third region, A-first clearance, B-second clearance;

10-end cap portion, 11-first flexible section, 12-second flexible section, 121-mounting cavity, 122-sound pickup hole, 13-first sound pickup device, 10a-contact layer, 10b-inner liner layer;

20-housing portion, 20a-accommodation cavity, 20b-first opening, 20c-second opening, 21-inner wall, 211-first through hole, 22-outer wall, 221-second through hole, 23-upper wall, 24-lower wall, 25-first limiting portion, 26-third limiting portion, 27-convex portion, 28-first guide portion;

30-adapter portion, 30a-first adapter cavity, 30b-second adapter cavity, 31-adapter inner shell, 311-insertion portion, 3111-fourth limiting portion, 3112-first adhesive groove, 32-adapter outer shell, 321-concave portion, 33-separator, 331-mounting hole, 332-second adhesive groove, 333-sealing member, 334-mounting portion;

40-ear hook portion;

50-loudspeaker, 51-loudspeaker bracket, 511-second limiting portion, 512-second guide portion, 52-flexible circuit board, 521-second electrical connection terminal;

60-circuit board assembly, 61-circuit board, 62-first electrical connection terminal.

### DETAILED DESCRIPTION

The present disclosure is further described in detail below with reference to the accompanying drawings and embodiments. Similar elements in different embodiments are referred to by associated similar element reference numerals. In the following embodiments, many details are described to facilitate a better understanding of the present disclosure. However, those skilled in the art will readily recognize that some features may be omitted in different situations, or may be replaced by other elements, materials, or methods. In some cases, certain operations related to the present disclosure are not shown or described in the specification. This is to avoid obscuring the core parts of the present disclosure with excessive description. For those skilled in the art, detailed description of these related operations is not necessary; they can fully understand the related operations based on the description in the specification and general technical knowledge in the art.

Furthermore, the features, operations, or characteristics described in the specification can be combined in any suitable manner to form various embodiments. At the same time, the steps or actions in the method description can be rearranged or adjusted in a manner obvious to those skilled in the art. Therefore, the various orders in the specification and drawings are only for the clear description of a particular embodiment and do not imply a necessary order, unless otherwise stated that a particular order must be followed.

The serial numbers assigned to components in the present disclosure, such as “first” and “second,” are used only to distinguish the described objects and have no sequential or technical meaning. The terms “connection” and “linkage” used in the present disclosure, unless otherwise specified, include both direct and indirect connections (linkages).

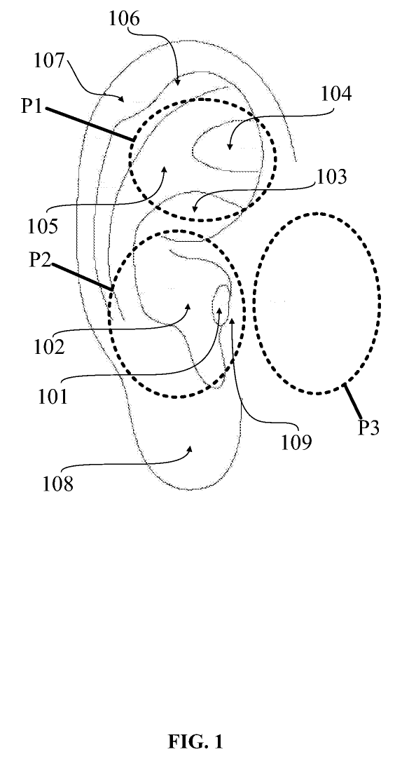

FIG. 1 is a schematic structural diagram illustrating a human ear according to some embodiments of the present disclosure. Referring to FIG. 1, the exemplary ear may include physiological parts such as an external ear canal 101, a cavum conchae 102, a cymba conchae 103, a triangular fossa 104, an antihelix 105, a scaphoid fossa 106, a helix 107, an earlobe 108, and a crus of helix 109. Although the external ear canal 101 has a certain depth and extends to the tympanic membrane of the ear, unless otherwise specified, the external ear canal 101 can be understood as an entrance (i.e., an earhole) away from the tympanic membrane. Furthermore, the physiological parts such as the cavum conchae 102, the cymba conchae 103, and the triangular fossa 104 have a certain volume and depth in a three-dimensional space, and the cavum conchae 102 is directly connected to the external ear canal 101. That is, the earhole may simply be regarded as being located at a bottom of the cavum conchae 102.

The earphone provided in some embodiments of the present disclosure can achieve stable wearing of the earphone by means of one or more physiological parts of the ear.

For example, since the external ear canal 101, the cavum conchae 102, the cymba conchae 103, the triangular fossa 104, and other physiological parts have a certain depth and volume in the three-dimensional space, they can meet the requirements for stable wearing of the earphone. When the earphone is in a wearing state, the whole or part structure of the earphone may contact an upper portion (e.g., one or more physiological parts such as the cavum conchae 102, the cymba conchae 103, the triangular fossa 104, the antihelix 105, the scaphoid fossa 106, the helix 107, the crus of helix 109, etc.) of the external ear canal 101. When the earphone is in the wearing state, the whole or part structure of the earphone may be located in one or more physiological parts of the ear, for example, in a first region P1 enclosed by dotted lines in FIG. 1, which includes at least the cymba conchae 103 and the triangular fossa 104, or in a second region P2 enclosed by dotted lines in FIG. 1, which includes at least the cavum conchae 102.

For example, when the earphone is in the wearing state, the whole or part structure of the earphone is located on a front side of the crus of helix 109, such as in a third region P3 enclosed by dotted lines in FIG. 1.

Due to individual differences among users, ears may vary in shape, size, and other dimensions. To facilitate description and understanding, and minimize or even eliminate these individual differences, unless otherwise specified, the present disclosure primarily uses an ear model with a “standard” shape and size as a reference to describe the structure of the earphone in different embodiments and a wearing mode of the earphone on the ear model. For example, a simulator (e.g., GRAS 45BC KEMAR) containing a head and its (left and right) ears is manufactured based on ANSI:S3.36, S3.25 and IEC:60318-7 standards as a reference for wearing the earphone, thus representing a scenario of most users normally wearing the earphone.

Accordingly, descriptions such as “user wearing,” “in the wearing state,” and “under the wearing state” in the present disclosure refer to the earphone described in the present disclosure being worn on the ears of the simulator. Considering the individual differences among different users, the structure, shape, size, thickness, or the like, of one or more parts of the earphone may be differentiated according to different ear shapes and sizes. These differentiated designs may be manifested in characteristic parameters of the one or more parts of the earphone having different ranges of values to adapt to different ears.

It should be noted that in fields such as medicine and anatomy, a sagittal plane, a coronal plane, and a horizontal plane can be defined as three basic planes of a human body, and a sagittal axis, a coronal axis, and a vertical axis can be defined as three basic axes.

The sagittal plane is a section perpendicular to the ground along a front-back direction of the body, which divides the body into left and right parts. The coronal plane is a section perpendicular to the ground along a left-right direction of the body, which divides the body into front and rear parts. The horizontal plane is a section parallel to the ground along a vertical direction of the body, which divides the body into upper and lower parts. Correspondingly, the sagittal axis is an axis along the front-back direction of the body and perpendicular to the coronal plane. The coronal axis is an axis along the left-right direction of the body and perpendicular to the sagittal plane. The vertical axis is an axis along the vertical direction of the body and perpendicular to the horizontal plane.

Furthermore, the “front side of the ear” mentioned in the present disclosure is a concept relative to “rear side of the ear”. The “front side of the ear” refers to a side of the ear facing a positive axial direction of the external ear canal 101, while the “rear side of the ear” refers to a side of the ear away from the positive axial direction of the external ear canal 101. Both the “front side of the ear” and the “rear side of the ear” are related to the ear of a user. The positive axial direction of the external ear canal 101 refers to a direction away from the tympanic membrane along an axial direction of the external ear canal 101. Observing the ear of the simulator along a direction of the coronal axis of the human body yields a schematic diagram of a contour of the front side of the ear shown in FIG. 1.

It should be noted that the above description of the ear is for illustrative purposes only and is not intended to limit the scope of the present disclosure. Those skilled in the art can make various changes and modifications based on the description in the present disclosure, and such changes and modifications still fall within the protection scope of the present disclosure.

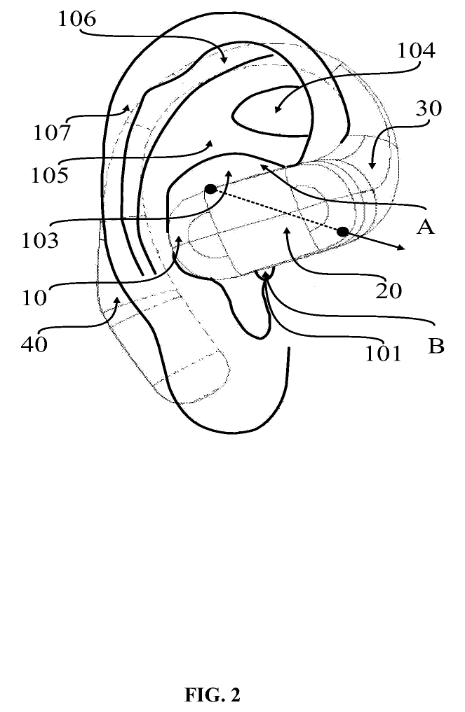

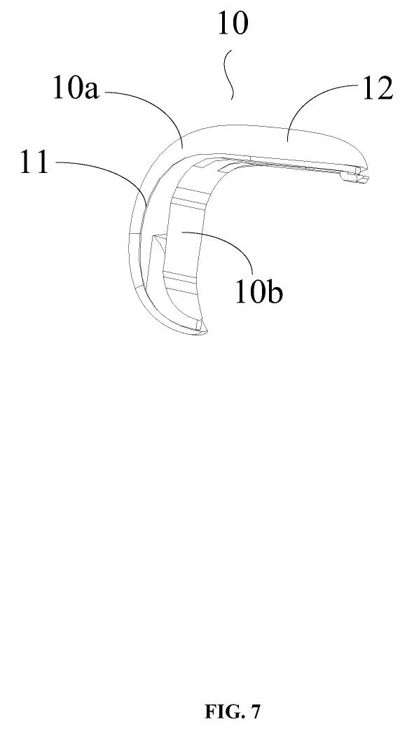

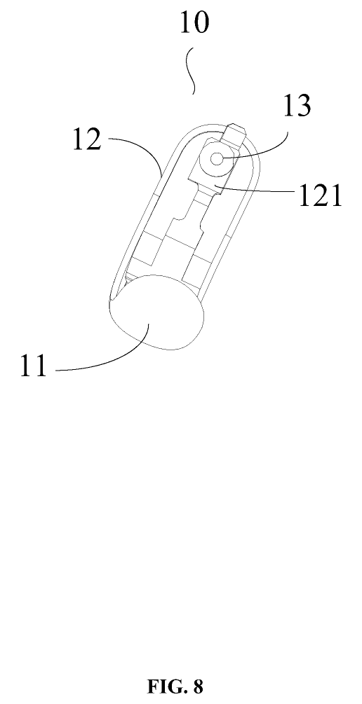

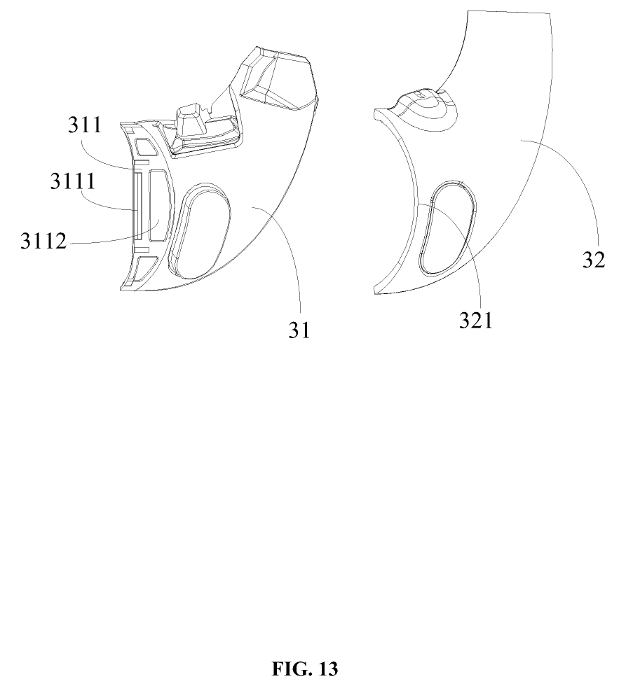

Referring to FIGS. 2-15, some embodiments of the present disclosure provide an earphone. The earphone may mainly include an end cap portion 10, a housing portion 20, an adapter portion 30, an ear hook portion 40, a loudspeaker 50, and a circuit board assembly 60. The earphone may further include a battery assembly, a microphone assembly, and other functional components as needed (e.g., an antenna structure, a button structure, a wear detection structure, etc.), which will be described in detail below.

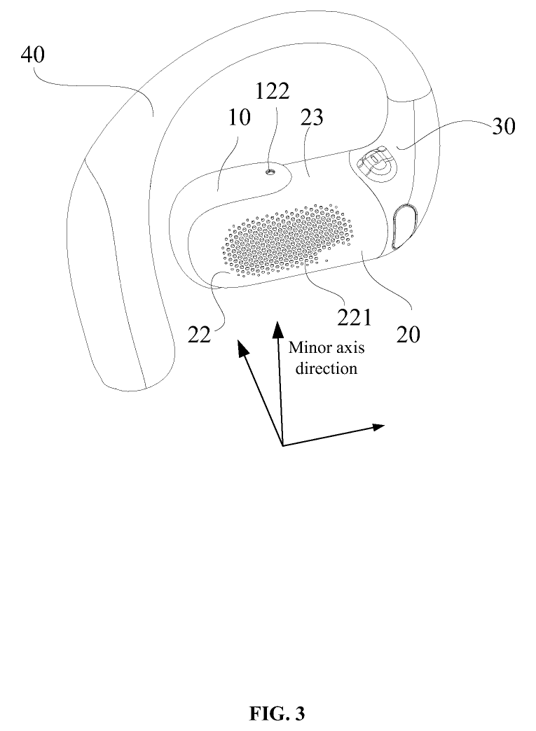

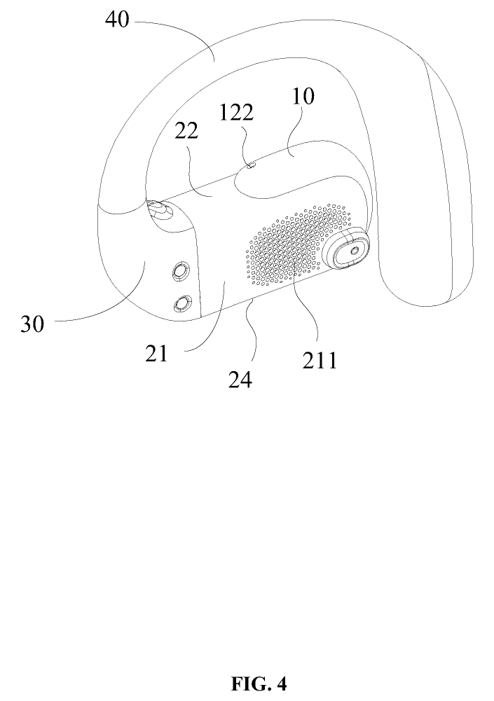

Referring to FIGS. 3-4, the adapter portion 30 is connected between the housing portion 20 and the ear hook portion 40. The housing portion 20, adapter portion 30, and ear hook portion 40 roughly constitute an overall outline of the earphone. The end cap portion 10 is connected to an end of the housing portion 20 away from the adapter portion 30. The housing portion 20 may provide a structural assembly space for components such as the loudspeaker 50 and the microphone assembly. One or more of the adapter portion 30 and ear hook portion 40 may provide a structural assembly space for functional components such as the circuit board assembly 60, the battery assembly, and the microphone assembly.

The adapter portion 30 may be understood as a transition structure connecting the housing portion 20 and the ear hook portion 40. In some embodiments, the adapter portion 30 is a portion of the housing portion 20. For example, a portion of the housing portion 20 used to connect the ear hook portion 40 and occupying a certain structural space is regarded as the adapter portion 30. In some embodiments, the adapter portion 30 is a portion of the ear hook portion 40. For example, a portion of the ear hook portion 40 used to connect the housing portion 20 and occupying a certain structural space is regarded as the adapter portion 30. In some embodiments, the housing portion 20, the adapter portion 30, and the ear hook portion 40 are relatively independent structures. By connecting the adapter portion 30 between the housing portion 20 and the ear hook portion 40, the general outline of the earphone can be assembled.

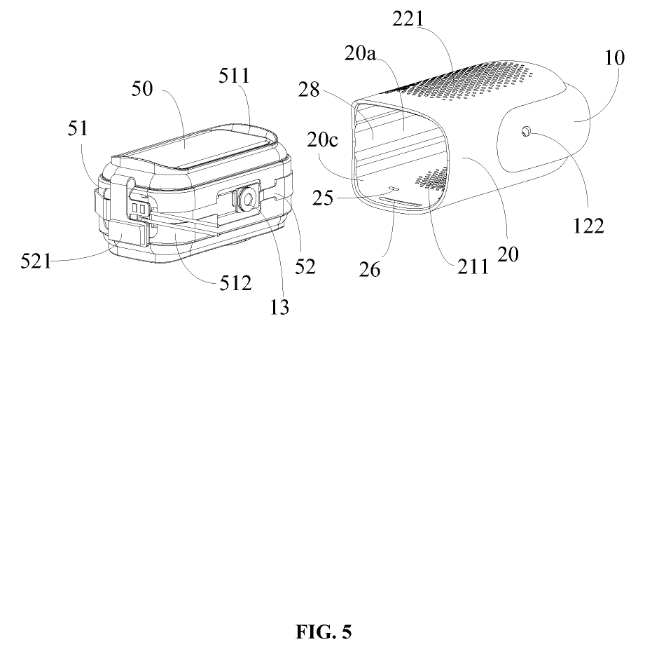

Referring to FIG. 5, the loudspeaker 50 may convert an electrical signal into a sound signal, and the loudspeaker 50 may be configured to output a noise reduced sound, a user voice, and an audio played according to user needs (e.g., music, a reminder sound, etc.). The circuit board assembly 60 may be understood as a collection of a main control board or a motherboard and related components of the earphone. The circuit board assembly 60 plays a role in regulating and managing all or some of the functional components of the earphone. For example, the circuit board assembly 60 is used in the earphone to convert and process the electrical signal to support implementation of various earphone functions (e.g., supporting the earphone in turning on and off, switching playback content, increasing or decreasing volume, etc.).

In some embodiments, referring to FIG. 2, in a wearing state of the earphone, the housing portion 20 is located on a front side of the ear, and at least a portion of the ear hook portion 40 is located between a rear side of the ear and the head, such that the earphone is hung on the ear in the wearing state. For example, the housing portion 20 is set to be located at a position near the external ear canal 101 but not blocking the external ear canal 101 in the wearing state, such that the earphone is an open earphone. It should be noted that due to individual differences among different users, when the earphone is worn by different users, the housing portion 20 may partially cover the external ear canal 101, but the external ear canal 101 is still not blocked.

To improve the stability of the earphone in the wearing state, the earphone may employ any one or a combination of the following modes.

In a first mode, at least a portion of the ear hook portion 40 is configured as a contoured structure (e.g., an arc-shaped hook) that conforms to at least one of the rear side of the ear and the head, thereby increasing a contact area between the ear hook portion 40 and the ear or the head, and thus increasing the resistance to the earphone falling off the ear.

In a second mode, at least a portion of the ear hook portion 40 is configured as an elastic structure, such that the ear hook portion 40 has a certain elastic deformation in the wearing state, to increase a pressure of the ear hook portion 40 on the ear or the head, thereby increasing the resistance to the earphone falling off the ear.

In a third mode, at least a portion of the ear hook portion 40 is configured to abut against the head in the wearing state, such that the ear hook portion 40 generates a reaction force that presses against the ear, causing the housing portion 20 to press against the front side of the ear, thereby increasing the resistance to the earphone falling off the ear.

In a fourth mode, the housing portion 20 and the ear hook portion 40 are configured to clamp the physiological parts such as a region where the helix 107 and a region where the cavum conchae 102 are located from the front and rear sides of the ear in the wearing state, thereby increasing the resistance to the earphone falling off the ear.

In a fifth mode, the housing portion 20 or other auxiliary structures (e.g., the adapter portion 30) connected to the housing portion 20 are configured to at least partially extend into physiological parts such as the cavum conchae 102, the cymba conchae 103, the triangular fossa 104, and the scaphoid fossa 106 in the wearing state, thereby increasing the resistance to the earphone falling off the ear.

Referring to FIGS. 2-6, in some embodiments, the end cap portion 10, the housing portion 20, and the adapter portion 30 are connected in sequence to form a three-section structure. The adapter portion 30 and the ear hook portion 40 may be an integral structure, in which case end portions of the end cap portion 10, the housing portion 20, and the ear hook portion 40 are connected in sequence to form a three-section structure.

The housing portion 20 has a major axis direction, a minor axis direction, and a thickness direction which are perpendicular to each other. The thickness direction is parallel to a vibration direction of the loudspeaker 50 within the housing portion 20. When the earphone is in the wearing state, the vibration direction of the loudspeaker 50 is parallel to the coronal axis and faces the human body. The vibration direction of the loudspeaker 50 faces an inner wall 21 of the housing portion 20 close to the human body, such that sound emitted by the loudspeaker 50 propagates towards the ear. When the earphone is in the wearing state, the major axis direction of the housing portion 20 may be approximately aligned with the sagittal axis of the human body, but may be slightly inclined relative to a front-back direction of the human body. The minor axis direction of the housing portion 20 may be approximately aligned with the vertical axis of the human body. The thickness direction of the housing portion 20 may be approximately aligned with the coronal axis of the human body. Referring to FIG. 2, the major axis direction is inclined relative to the sagittal axis of the human body, and the major axis direction is closer to the sagittal axis than the minor axis direction; the minor axis direction is inclined relative to the vertical axis of the human body, and the minor axis direction is closer to the vertical axis than the major axis direction.

The end cap portion 10, the housing portion 20, and the adapter portion 30 are connected and arranged in sequence along the major axis direction of the housing portion 20, to form a three-section structure along the major axis direction. An arrangement direction of the three-section structure (the major axis direction) is not parallel to the vibration direction of the loudspeaker 50. For example, the major axis direction and the vibration direction form a relatively large intersection angle. As another example, the major axis direction and the vibration direction are perpendicular to each other. This arrangement allows connections of the three-section structure to be staggered as much as possible from the vibration direction of the loudspeaker 50, avoiding the impact of clearances that may appear at the connections of the three-section structure after long-term use on the sound output performance of the loudspeaker 50.

The housing portion 20 may be a cylindrical structure. The housing portion 20 of the cylindrical structure may be provided with an accommodation cavity 20a. An end of the housing portion 20 along the major axis direction is provided with a first opening 20b, and the other end of the housing portion 20 along the major axis direction is provided with a second opening 20c. The first opening 20b and the second opening 20c are located at two ends of the accommodation cavity 20a, respectively, and are in communication with the accommodation cavity 20a.

The cylindrical structure of the housing portion 20 may be a rectangular structure, a cylindrical structure, an elliptical structure, a rhombic structure, etc. It is understood that any cavity structure with openings at two ends may serve as a specific structure of the housing portion 20 and falls within the scope of protection of the present disclosure.

In the three-section structure, two sides of the housing portion 20 are provided with the first opening 20b and the second opening 20c, respectively. The end cap portion 10 may cover the first opening 20b, and the adapter portion 30 may cover the second opening 20c. The end cap portion 10, the housing portion 20, and the adapter portion 30 may be quickly assembled along the major axis direction. The housing portion 20 may form a cylindrical structure with openings at two ends. The cylindrical structure of the housing portion facilitates mounting of internal components of the housing portion. The three-section structure of the earphone simplifies the mounting difficulty of the end cap portion 10, the housing portion 20, the adapter portion 30, and the loudspeaker 50, and improves the assembly efficiency of the earphone.

The end cap portion 10 may cover the first opening 20b and be connected to the housing portion 20. At least a portion of the end cap portion 10 may abut against a cavum conchae wall in the wearing state of the earphone. The entire end cap portion 10 or an outer layer of the end cap portion 10 may be made of a flexible material to improve user comfort in the wearing state. The adapter portion 30 may cover the second opening 20c and be connected to the housing portion 20. In a finished product, the end cap portion 10 and the adapter portion 30 may cover the first opening 20b and the second opening 20c, respectively. In some embodiments, the three-section structure may be tightly connected, with no clearances at the connections or clearances sealed at the connections by a waterproof structure, to ensure the airtightness of the housing portion 20 and prevent water ingress.

In some embodiments, the first opening 20b and the second opening 20c may have a sufficient opening size, and an opening area of at least one of the first opening 20b or the second opening 20c may be greater than a maximum cross-sectional area of the loudspeaker in a cross section taken parallel to the vibration direction of the loudspeaker 50. This allows the loudspeaker 50 to be inserted into the accommodation cavity 20a of the housing portion 20 through the first opening 20b or the second opening 20c when earphone is assembled, and then the end cap portion 10 and the adapter portion 30 are respectively mounted in the first opening 20b and the second opening 20c. In this embodiment, the loudspeaker 50 is mounted in the housing portion 20 through the first opening 20b or the second opening 20c, such that mounting of the loudspeaker 50 is facilitated.

In some embodiments, the loudspeaker 50 may be disposed in the accommodation cavity 20a of the housing portion 20 using an insertion mode, allowing the loudspeaker 50 fixedly mounted upon insertion. For example, a limiting portion is provided inside the housing portion 20, and another limiting portion is provided on an outer shell of the loudspeaker 50. The limiting portion of the housing portion 20 and the limiting portion of the loudspeaker 50 may be complementary and adaptable structures such as a fastener and a slot. After the loudspeaker 50 is inserted into the accommodation cavity 20a of the housing portion 20, the corresponding two limiting portions are engaged, thereby fixing and limiting the loudspeaker 50. That is, the loudspeaker 50 may be mounted and fixed using a one-step insertion mode, which simplifies the mounting steps and improves the mounting efficiency. Furthermore, the mounting accuracy of the loudspeaker 50 can be guaranteed, making the vibration direction of the loudspeaker 50 be parallel to the thickness direction of the housing portion 20.

In some embodiments, the opening size of the first opening 20b and the opening size of the second opening 20c may accommodate the insertion and mounting of the loudspeaker 50 into the housing portion 20, thus providing a great mounting flexibility for the loudspeaker 50. If a structure or a positioning structure of the loudspeaker 50 is different, the loudspeaker 50 may be inserted and mounted into the housing portion 20 through the at least one of the first opening 20b or the second opening 20c according to a specific structure. Furthermore, both the first opening 20b and the second opening 20c can realize insertion of the loudspeaker 50, thereby facilitating disassembly of the loudspeaker 50 during maintenance. For example, the loudspeaker 50 is inserted through one of the first opening 20b and the second opening 20c and pulled out through the other of the first opening 20b and the second opening 20c, thereby allowing a flexible circuit board, or the like, to be assembled and disassembled in one direction, and preventing damage to the flexible circuit board by folding back.

It is understood that in some embodiments of the present disclosure, the housing portion 20 may be formed by combining two housings. When the loudspeaker 50 is mounted in the accommodation cavity 20a of the housing portion 20, the loudspeaker 50 is first mounted on one of the two housings, and then the other of the two housings is fixed to the housing on which the loudspeaker 50 is mounted to form the housing portion 20 with openings at the two ends, and then the end cap portion 10 and the adapter portion 30 are mounted, respectively.

Referring to FIG. 3, in this embodiment, the housing portion 20 is an integrated cylindrical structure. The major axis direction of the housing portion 20 is perpendicular to the vibration direction of the loudspeaker 50, where being perpendicular includes being absolutely perpendicular and being approximately perpendicular. The first opening 20b and the second opening 20c are located at the two ends of the housing portion 20 along the major axis direction. The housing portion 20 may form a straight cylindrical structure, which simplifies the structure of the housing portion 20 and allows the first opening 20b and the second opening 20c to directly communicate with the accommodation cavity 20a of the housing portion 20. The first opening 20b, the accommodation cavity 20a, and the second opening 20c may be distributed on a straight line, allowing the loudspeaker 50 to be linearly inserted into the accommodation cavity 20a along the major axis direction. This structure makes the mounting mode simpler and more efficient. Furthermore, an opening direction of the first opening 20b and an opening direction of the second opening 20c are completely staggered from the vibration direction of the loudspeaker 50. Connection structures at the first opening 20b and the second opening 20c do not affect the sound output of the loudspeaker 50. For example, the connection structures do not obstruct the sound output effect, or if there is a clearance in the connection structures, the sound output effect is not interfered.

In this embodiment, the end cap portion 10, the housing portion 20, and the adapter portion 30 are connected in sequence to form a three-section structure. In this three-section structure, the loudspeaker 50 may be directly inserted into the housing portion 20 through the openings on the two sides of the housing portion 20. This mounting mode allows for one-step insertion of the loudspeaker 50, eliminating the need to first fix the loudspeaker 50 to one of the housings of the housing portion 20 before assembly. In other words, the three-section structure of the earphone simplifies the mounting steps of the loudspeaker and improves the assembly efficiency.

The three-section structure of the earphone improves the mounting stability of the loudspeaker 50. The outer wall of the large-sized loudspeaker 50 may directly abut against the inner wall of the housing portion 20, and the cylindrical structure of the housing portion 20 may bind, wrap, limit, and fix the loudspeaker 50, thereby improving the mounting stability of the loudspeaker.

The three-section structure of the earphone simplifies the structure of the housing portion 20. The openings at the two ends of the housing portion 20 may be used as mating mounting ports or as wiring mounting ports for routing a flexible circuit board or threading a cable. The openings at the two ends of the housing portion 20 facilitate electrical connection between the loudspeaker 50 and other components, and simplify the structure of the housing portion 20, eliminating the need for separate mounting ports and wiring mounting ports.

The three-section structure of the earphone may create a more aesthetically pleasing shape. The housing portion 20 may be made into an integral structure. The outer surface of the cylindrical housing portion 20 may be a smooth and seamless surface, which is more beautiful. In particular, when the outer surface of the housing portion 20 is painted, a complete pattern can be formed.

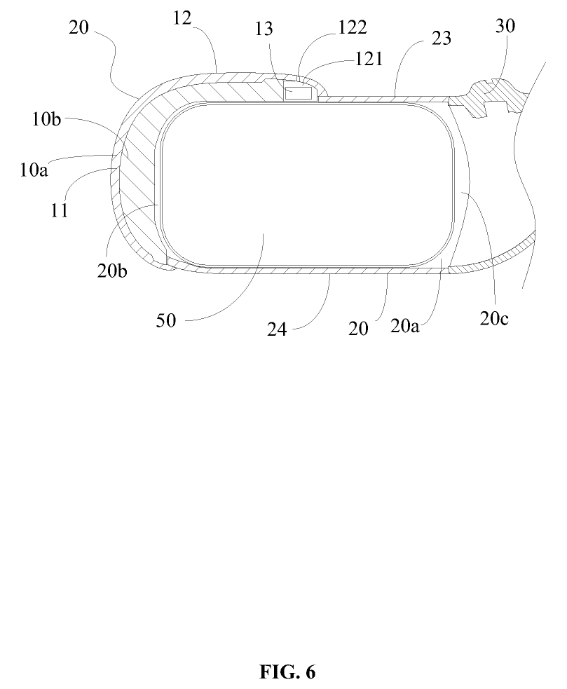

Referring to FIG. 6, in some embodiments, one of the first opening 20b and the second opening 20c has a sufficient opening size, i.e., an opening area of one of the first opening 20b and the second opening 20c is greater than a maximum cross-sectional area of the loudspeaker 50 in a cross section taken parallel to the vibration direction of the loudspeaker 50, and an opening area of the other of the first opening 20b and the second opening 20c is less than the maximum cross-sectional area of the loudspeaker 50 in the cross section taken parallel to the vibration direction of the loudspeaker 50. For example, the first opening 20b is relatively small, which does not allow the loudspeaker 50 to be inserted and mounted into the housing portion 20 through the first opening 20b, while the second opening 20c is relatively large, which allows the loudspeaker 50 to be inserted and mounted into the housing portion 20 through the second opening 20c. As another example, the first opening 20b is relatively large, which allows the loudspeaker 50 to be inserted and mounted into the housing portion 20 through the first opening 20b, while the second opening 20c is relatively small, which does not allow the loudspeaker 50 to be inserted and mounted into the housing portion 20 through the second opening 20c. In this structure, the opening at one end of the housing portion 20 allows the loudspeaker 50 to be inserted and mounted into the housing portion 20, and allows the loudspeaker 50 to be inserted and mounted in one step, thereby achieving the advantages of high mounting efficiency, more accurate positioning, and more stable structure.

In some embodiments, the major axis direction of the housing portion 20 is not parallel to the vibration direction of the loudspeaker 50. For example, the major axis direction of the housing portion 20 intersects with the vibration direction of the loudspeaker 50, and an angle between the major axis direction of the housing portion 20 and the vibration direction of the loudspeaker 50 is 45° or 60°. In this structure, the loudspeaker 50 may be mounted into the accommodation cavity 20a of the housing portion 20 along an inclined direction, and the loudspeaker 50 may be quickly inserted. The first opening 20b and the second opening 20c may be staggered from the vibration direction of the loudspeaker 50, and the connection structures at the first opening 20b and the second opening 20c do not affect the sound output of the loudspeaker 50.

Referring to FIG. 3 and FIG. 4, in some embodiments, the housing portion 20 may include an inner wall 21 facing the ear, an outer wall 22 away from the ear, an upper wall 23 facing upward, and a lower wall 24 facing downward along the vibration direction of the loudspeaker 50 in the wearing state. The inner wall 21 and outer wall 22 may be located on two sides of the housing portion 20 in the thickness direction (the vibration direction of the loudspeaker 50), respectively, the upper wall 23 and lower wall 24 may be located on two sides of the housing portion 20 in the minor axis direction, respectively, and the first opening 20b and second opening 20c may be located on the two sides of the housing portion 20 in the major axis direction, respectively. The outer wall 22, the upper wall 23, the inner wall 21, and the lower wall 24 may be enclosed in sequence to form the accommodation cavity 20a. The outer wall 22, the upper wall 23, the inner wall 21, and the lower wall 24 may be a planar or curved structure. Rounded chamfers may be provided at connections among the outer wall 22, the upper wall 23, the inner wall 21, and the lower wall 24, making the outer contour of the housing portion 20 smoother, and improving wearing comfort and aesthetics.

When the earphone is in the wearing state, the earphone has an inner surface facing the user and an outer surface away from the user, and a side surface connected to the inner surface and the outer surface. A flexible portion may be located on the side surface. In some embodiments of the present disclosure, the inner surface of the earphone may be an outer surface of the inner wall 21 of the housing portion 20, the outer surface of the earphone may be an outer surface of the outer wall 22 of the housing portion 20, and the side surface of the earphone may be a surface between the outer surface of the inner wall 21 and the outer surface of the outer wall 22.

The housing portion 20 may be made of a rigid structural material such as metal or plastic. The housing portion 20 made of the rigid structural material may form a stable accommodation cavity 20a to achieve secure mounting of components such as the loudspeaker 50. In some embodiments, the housing portion 20 may be made of metal and has a glossy outer surface to enhance the texture and aesthetics of the earphone.

The housing portion 20 may be a single-layer structure with a relatively small thickness. A reinforcing structure may be provided inside the housing portion 20 to minimize a weight of the earphone while ensuring a strength of the earphone. In some embodiments, the reinforcing structure may form a snap-fit portion to position and fix the loudspeaker 50. The housing portion 20 may employ a multi-layer composite structure. For example, the housing portion 20 may include an inner liner and an outer layer, where the inner liner may be a support layer with a relatively high structural strength, and the outer layer may be a metal or silicone layer with good tactile and wearing feel.

The housing portion 20 may be an integral structure. The housing portion 20 may be integrally formed from a single material or a mixture of materials. The integrally formed housing portion 20 has higher structural stability and may create a seamless surface. It is understood that in other embodiments of the present disclosure, the housing portion 20 may be formed by splicing a plurality of housings together through snap-fitting, welding, bonding, or other modes.

Referring to FIG. 3 and FIG. 4, in some embodiments, the inner wall 21 of the housing portion 20 may be provided with a first through hole 211 penetrating through the inner wall 21. The first through hole 211 is in acoustic communication with a sound producing surface of the loudspeaker 50 (i.e., allowing sound to propagate between the first through hole 211 and the loudspeaker 50), and the sound producing surface of the loudspeaker 50 may face the first through hole 211. The first through hole 211 may be a sound outlet hole, and sound emitted by the loudspeaker 50 may pass through the first through hole 211 and enter the ear. The outer wall 22 of the housing portion 20 is provided with a second through hole 221 penetrating through the outer wall 22. The sound producing surface of the loudspeaker 50 is away from the second through hole 221. The second through hole 221 may be a pressure reducing hole, and the second through hole 221 may provide ventilation and pressure reduction for the loudspeaker 50 within the housing portion 20, thereby improving the audio playback quality of the loudspeaker 50 and achieving a relatively high level of active noise reduction.

The first through hole 211 and the second through hole 221 may be a micro-hole array structure. It is understood that the micro-hole array structure is an array structure with tiny pores; and these pores may be formed by drilling directly on a side wall of the housing portion 20, or these pores refer to small holes in an acoustic steel mesh or acoustic yarn (i.e., the inner wall 21 or the outer wall 22 may be made of an acoustic steel mesh or acoustic yarn).

On the one hand, by utilizing the micro-hole array structure of the first through hole 211 and the second through hole 221, the rigidity of the housing portion 20 can be guaranteed while ensuring the effective area for sound output. This allows the earphone to have sufficient strength while ensuring high-intensity sound output, thereby providing support for ensuring sound quality and enhancing the effect of active noise reduction.

On the other hand, by setting the first through hole 211 and the second through hole 221 into the micro-hole array structure, and acoustically connecting the two sides of the loudspeaker 50 in the vibration direction to the first through hole 211 and the second through hole 221, respectively, while ensuring sound output efficiency, the internal air pressure can be balanced when the loudspeaker 50 vibrates. This configuration can avoid the problems that are easily caused by using a single through hole with a large aperture, such as affecting the overall appearance of the earphone, accumulating dirt and impurities, and requiring an additional pressure relief hole. This configuration can also avoid the problems that are easily caused by using a single through hole with a small aperture, such as high acoustic impedance, low sound output efficiency, and poor sound effect.

In other embodiments, the first through hole 211 and the second through hole 221 may adopt a single-hole structure or a multi-hole structure with a relatively large aperture. By covering the first through hole 211 and the second through hole 221 with the acoustic steel mesh or the acoustic yarn, the technical effect of waterproofing and dustproofing can be achieved while ensuring the effective area of sound output.

In some embodiments, the inner wall 21 of the housing portion 20 has only the first through hole 211 penetrating through the inner wall 21, and the sound producing surface of the loudspeaker 50 faces the first through hole 211. The outer wall 22 of the housing portion 20 does not have the second through hole 221. This configuration can meet the needs of some scenarios with lower sound quality requirements or some users with lower sound quality requirements.

Referring to FIG. 5, in some embodiments, the earphone may further include a loudspeaker bracket 51. The loudspeaker bracket 51 may be a frame structure. The loudspeaker bracket 51 may be composed of a plurality of plates or sheet-like structures. For example, the loudspeaker bracket 51 is a ring structure. The loudspeaker 50 may be mounted inside the loudspeaker bracket 51, and the loudspeaker bracket 51 may be mounted at a periphery of the loudspeaker 50. The loudspeaker bracket 51 may surround side surfaces of the loudspeaker 50 in the major axis direction and the minor axis direction. The loudspeaker bracket 51 may not cover a side surface of the loudspeaker 50 in the vibration direction (thickness direction) to avoid obstructing the sound output of the loudspeaker 50. The loudspeaker bracket 51 may also have other structures, such as a C-shaped structure. The C-shaped structure may also achieve positioning and mounting of the loudspeaker 50.

With the arrangement of the loudspeaker bracket 51, the loudspeaker bracket 51 is configured to mount and fix the loudspeaker 50 within the housing portion 20. The loudspeaker bracket 51 may be snap-fitted with the housing portion 20, and the loudspeaker 50 may be a standard structural component. The loudspeaker bracket 51 may be snap-fitted with the housing portion 20 using elastic deformation; similarly, the loudspeaker bracket 51 may be fixed to the loudspeaker 50 using elastic deformation. During mounting, the loudspeaker 50 may be first mounted on the loudspeaker bracket 51 to form a combination, and then the combination of the loudspeaker 50 and loudspeaker bracket 51 may be inserted into the housing portion 20.

On the other hand, the earphone may further include electrical connection components such as a flexible circuit board 52. The loudspeaker bracket 51 may be configured to limit and fix the flexible circuit board 52 and other electrical connection components that are electrically connected to the loudspeaker 50. The flexible circuit board 52 and other electrical connection components may be fixed to the loudspeaker bracket 51 by means of insertion, embedding, or snap-fitting. The flexible circuit board 52 and other electrical connection components may be clamped and mounted between the loudspeaker bracket 51 and the loudspeaker 50. After the flexible circuit board 52 and other electrical connection components are fixedly mounted on the loudspeaker bracket 51, when the flexible circuit board 52 and other electrical connection components and the loudspeaker bracket 51 are inserted into the housing portion 20 together, the flexible circuit board 52 and other electrical connection components may not be disturbed by the insertion, which can ensure the stability of the electrical connection between the flexible circuit board 52 and other electrical connection components and the loudspeaker 50, and facilitate the quick mounting of the loudspeaker 50 and the flexible circuit board 52 and other electrical connection components.

In some embodiments, the earphone may not include the loudspeaker bracket 51. An outer surface of the loudspeaker 50 may be provided with a snap-fitting or limiting structure inside the housing portion 20, which can achieve fixed connection between the loudspeaker 50 and the housing portion 20. Alternatively, the outer surface of the loudspeaker 50 may be directly bonded to the inner wall of the housing portion 20 by an adhesive, or the like. The outer surface of the loudspeaker 50 may be provided with a snap-fitting hole or limiting hole or other limiting and fixing structures to mount and fix electrical connection components such as the flexible circuit board 52.

Referring to FIG. 5, in some embodiments, an inner side wall of the housing portion 20 (a side wall of the accommodation cavity 20a) may be provided with a first limiting portion 25, and the loudspeaker bracket 51 may be provided with a second limiting portion 511 corresponding to the first limiting portion 25. The first limiting portion 25 and the second limiting portion 511 may be complementary and adaptable limiting connection structures. For example, one of the first limiting portion 25 and the second limiting portion 511 is a fastener, and the other of the first limiting portion 25 and the second limiting portion 511 is a slot. The limiting connection between the first limiting portion 25 and the second limiting portion 511 may limit and fix the loudspeaker bracket 51 inside the housing portion 20, thereby limiting and fixing the loudspeaker 50 at a preset position inside the housing portion 20. The first limiting portion 25 and the second limiting portion 511 may be elastically deformed and engaged, and an elastic deformation force between the first limiting portion 25 and the second limiting portion 511 may improve the connection stability between the loudspeaker bracket 51 and the housing portion 20.

Referring to FIG. 5, in some embodiments, the inner side wall of the housing portion 20 (the side wall of the accommodation cavity 20a) may be provided with a first guide portion 28, and the loudspeaker bracket 51 may be provided with a second guide portion 512 corresponding to the first guide portion 28. The first guide portion 28 and the second guide portion 512 may be slidable structures that are structurally complementary and adaptable to each other. For example, one of the first guide portion 28 and the second guide portion 512 is a groove, and the other of the first guide portion 28 and the second guide portion 512 is a raised slider capable of sliding relative to the groove. A guide sliding direction of the first guide portion 28 and the second guide portion 512 may be parallel to the major axis direction of the housing portion 20. That is, the guide sliding direction of the first guide portion 28 and the second guide portion 512 may be parallel to an insertion direction of the loudspeaker bracket 51. The arrangement of the first guide portion 28 and the second guide portion 512 allows the combination of the loudspeaker bracket 51 and the loudspeaker 50 to be inserted into the housing portion 20 along the guide direction (the major axis direction), which can improve the accuracy of inserting and mounting the combination of the loudspeaker bracket 51 and the loudspeaker 50 into the housing portion 20.

The first guide portion 28 may be provided only on one side surface of the inner side wall of the housing portion 20, or the inner side wall of the housing portion 20 may be provided with a plurality of asymmetrical first guide portions 28, and one or more second guide portions 512 may be provided at corresponding positions of the loudspeaker bracket 51. With this arrangement, the first guide portion 28 and the second guide portion 512 may play a foolproof role, preventing the loudspeaker 50 from being mounted in the wrong direction or in reverse.

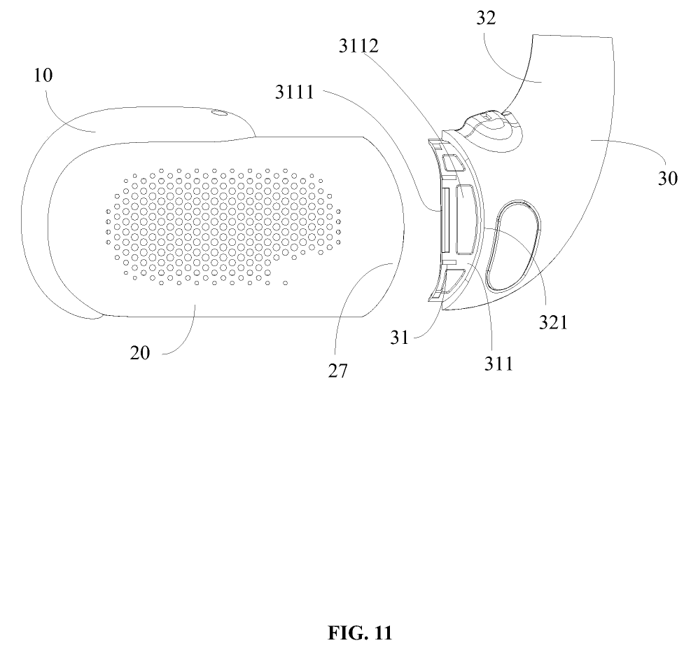

Referring to FIGS. 11-13, in some embodiments, the adapter portion 30 may include an adapter inner shell 31 and an adapter outer shell 32. The adapter inner shell 31 may be connected to the housing portion 20. The adapter outer shell 32 may cover an outer side of the adapter inner shell 31 in a sleeved manner. The adapter outer shell 32 and the adapter inner shell 31 may be connected by snap-fitting, bonding, welding, interference fitting, or other modes. The adapter outer shell 32 may be connected to the ear hook portion 40 (e.g., an ear hook cover) by bonding, welding, or other modes. A Shore hardness of the adapter outer shell 32 may be less than a Shore hardness of the adapter inner shell 31. For example, the adapter outer shell 32 is made of silicone or rubber, while the adapter inner shell 31 is made of a relatively hard plastic material or other insulating materials.

The adapter inner shell 31 is relatively rigid, which can stabilize a contour of the adapter portion 30 and provide structural support for assembling components such as the button structure and the circuit board assembly 60 onto the adapter portion 30. The adapter outer shell 32 is relatively soft, which can come into contact with human skin in the wearing state, thereby effectively improving the wearing comfort of the earphone. The combination of soft and rigid materials facilitates the disassembly and maintenance of the adapter portion 30 and related components, and enhances the stability of the structural connection between the adapter portion 30, the housing portion 20, and the ear hook portion 40.

In some embodiments, referring to FIGS. 3-4, the adapter outer shell 32 and the ear hook cover of the ear hook portion 40 may be an integral structure. For example, the adapter outer shell 32 and the ear hook cover are an integral structure (e.g., a tubular structure) made of a silicone material; the adapter inner shell 31 is a shell structure made of a hard material such as plastic. The adapter inner shell 31 may be inserted into the adapter outer shell 32 by means of interference fitting, bonding, etc., thereby constructing the adapter portion 30 into a structural form with a cavity.

In this way, the integrity of the contour structure of the ear hook portion 40 and the adapter portion 30 can be guaranteed based on the integrated structure of the adapter outer shell 32 and the ear hook cover. The adapter portion 30 can be quickly formed by inserting the adapter inner shell 31 into the adapter outer shell 32, which supports improved structural stability of the adapter portion 30 and facilitates rapid assembly and disassembly of related components.

In some embodiments, the adapter portion 30 may be a single-layer structure, and the adapter portion 30 and the ear hook portion 40 may be an integral structure.

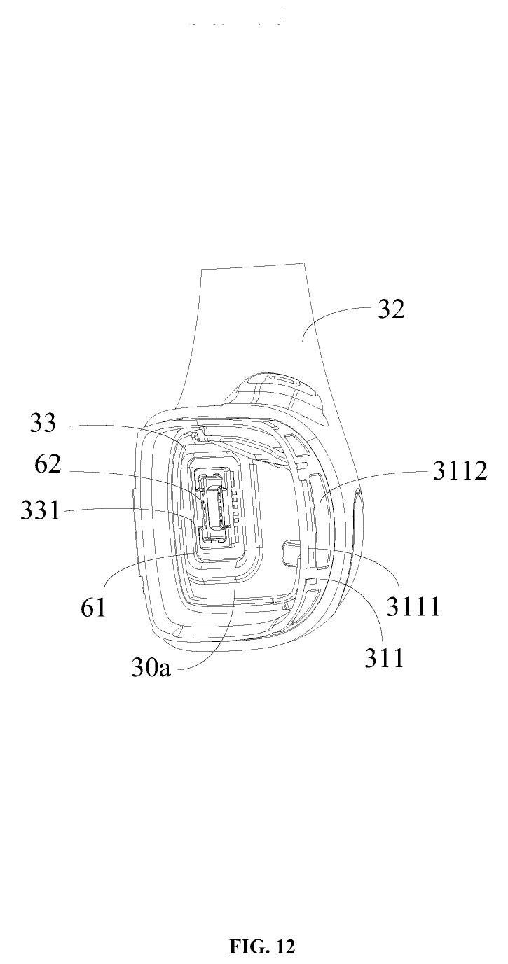

Referring to FIGS. 11-12, in some embodiments, an end of the adapter inner shell 31 close to the housing portion 20 protrudes from the adapter outer shell 32 to form an insertion portion 311. That is, one end of the adapter inner shell 31 is not covered by the adapter outer shell 32. The insertion portion 311 may be inserted into the second opening 20c of the housing portion 20 and fixedly connected to the housing portion 20. An outer surface of the adapter outer shell 32 may be flush with an outer surface of the housing portion 20 to form a smoother and more integrated shape, improving the feel and aesthetics of the earphone.

A third limiting portion 26 may be provided at a position on the inner side wall of the housing portion 20 close to the second opening 20c, and a fourth limiting portion 3111 may be provided on an outer circumferential side surface of the insertion portion 311 of the adapter inner shell 31. The third limiting portion 26 and the fourth limiting portion 3111 may be complementary and adaptable limiting connection structures. For example, one of the third limiting portion 26 and the fourth limiting portion 3111 is a fastener, and the other of the third limiting portion 26 and the fourth limiting portion 3111 is a slot. Snap-fitting formed by the third limiting portion 26 and the fourth limiting portion 3111 may fix the insertion portion 311 into the housing portion 20, thereby realizing a fixed connection between the housing portion 20 and the adapter portion 30.

Referring to FIGS. 11-12, in some embodiments, the outer circumferential side surface of the insertion portion 311 may be provided with a first adhesive groove 3112. Before the insertion portion 311 is inserted into the housing portion 20, an adhesive may be pre-filled in the first adhesive groove 3112. After the insertion portion 311 is inserted into the housing portion 20, the adhesive may contact the inner side wall of the housing portion 20. After the adhesive cures, the adhesive may bond and fix the insertion portion 311 and the housing portion 20, further improving the stability of the connection between the housing portion 20 and the adapter portion 30. The adhesive may play a sealing role in sealing a clearance at the connection between the housing portion 20 and the adapter portion 30 to prevent water from entering from the connection between the housing portion 20 and the adapter portion 30. The first adhesive groove 3112 may form an accommodation cavity to accommodate more adhesive. More adhesive may improve the stability of the bonding between the housing portion 20 and the adapter portion 30 and improve the sealing effect.

In some embodiments, the first adhesive groove 3112 may be provided on the inner side wall of the housing portion 20, or the first adhesive groove 3112 may not be provided, and the adhesive may be applied to an outer circumferential wall of the insertion portion 311 or the inner side wall of the housing portion 20, which can achieve the bonding between the insertion portion 311 and the housing portion 20.

In some embodiments, no limiting component may be provided between the insertion portion 311 and the housing portion 20. The insertion portion 311 and the housing portion 20 may be fixedly connected directly by means of interference fitting, bonding, or other modes.

In some embodiments, as shown in FIG. 5, FIG. 6, and FIG. 12, an end surface of the housing portion 20 provided with the second opening 20c may be a first inclined surface. The first inclined surface may be inclined relative to a cross section taken parallel to the vibration direction of the loudspeaker 50. If the end surface of the housing portion 20 having the second opening 20c is not provided with an inclined surface, the end surface may be perpendicular to the outer surface of the housing portion 20; and the first inclined surface may be inclined relative to the outer surface of the housing portion 20. Correspondingly, an end surface of the adapter outer shell 32 close to the housing portion 20 may be a second inclined surface. The second inclined surface may be inclined relative to the cross section taken parallel to the vibration direction of the loudspeaker 50. Similarly, the second inclined surface may be inclined relative to the outer surface of the adapter outer shell 32, and inclination angles and inclination directions of the first inclined surface and the second inclined surface may be the same. When the housing portion 20 and the adapter outer shell 32 are mated, the first inclined surface and the second inclined surface may be adapted to be mated. The inclination angles of the first inclined surface and the second inclined surface may be set according to requirements. For example, the inclination angles of the first inclined surface and the second inclined surface are both +45° or both -30°. The setting of the first inclined surface and the second inclined surface increases a contact area between the adapter outer shell 32 and the housing portion 20, which can improve the stability of the connection between the adapter outer shell 32 and the housing portion 20, and increase a path length from the outside to the inside of the connection between the adapter outer shell 32 and the housing portion 20, thereby improving the sealing performance and achieving a better water-resistant effect.

In some embodiments, the first inclined surface and the second inclined surface may be replaced by surfaces of other shapes and structures, which can also improve the sealing performance of the adapter outer shell 32 and the housing portion 20.

For example, the first inclined surface and the second inclined surface are replaced by complementary wave-shaped or serrated surfaces, which not only increase the contact area between the adapter outer shell 32 and the housing portion 20 and improve the sealing performance of the adapter outer shell 32 and the housing portion 20, but also limit axial rotation and improve the accuracy of the connection between the adapter outer shell 32 and the housing portion 20.

As another example, one of the first inclined surface and the second inclined surface is replaced by a concave surface, and the other of the first inclined surface and the second inclined surface is replaced by a convex surface. The concave surface and the convex surface may be adapted to each other, and the mating of the concave surface and the convex surface may increase the contact area between the adapter outer shell 32 and the housing portion 20, thereby improving the sealing performance of the adapter outer shell 32 and the housing portion 20.

In some embodiments, the end surface of the adapter outer shell 32 close to the housing portion 20 may elastically abut against the end surface of the housing portion 20 provided with the second opening 20c, making it difficult for external liquid to enter into the housing portion 20 from the connection between the adapter outer shell 32 and the housing portion 20, thereby achieving sealing between the adapter outer shell 32 and the housing portion 20 to protect the loudspeaker 50 inside the housing portion 20, and improving the waterproof effect of the earphone.

In some embodiments, a portion of the adapter outer shell 32 may extend above the first adhesive groove 3112 of the insertion portion 311 of the adapter inner shell 31. For example, an end portion provided with the second inclined surface at least partially extends above the first adhesive groove 3112. This configuration ensures that during mounting, the adhesive covers a position below the connection between the adapter outer shell 32 and the housing portion 20, providing sealing at the connection between the adapter outer shell 32 and the housing portion 20, thereby achieving a better sealing effect.

In some embodiments, at least a portion of the housing portion 20 may extend along the major axis direction toward the adapter portion 30 to form a convex portion 27. The adapter outer shell 32 may be provided with a concave portion 321 complementary to the convex portion 27. The concave portion 321 of the adapter outer shell 32 may expose a larger area of the adapter inner shell 31. The insertion portion 311 may be provided with an exposed region formed by avoidance of the concave portion 321. The exposed region may have a larger area, and the first adhesive groove 3112 may be located in the exposed region. This configuration increases an area of the outer circumferential wall of the insertion portion 311 of the adapter inner shell 31, thereby increasing the contact area between the housing portion 20 and the adapter inner shell 31. This configuration allows for a larger volume of the first adhesive groove 3112 to inject more adhesive. More adhesive may improve the insertion stability and sealing between the housing portion 20 and the adapter inner shell 31.

For example, an end of the outer wall 22 of the housing portion 20 close to the adapter outer shell 32 is provided with the extended convex portion 27, and a corresponding front side wall of the adapter outer shell 32 is provided with the concave portion 321. The convex portion 27 and the concave portion 321 may be a convex arc edge structure and a concave arc edge structure, respectively. By placing the convex portion 27 on the front side of the housing portion 20, an arc connection line between the housing portion 20 and the adapter outer shell 32 is displayed, which can improve the aesthetics of the design. Meanwhile, the arc connection line may be combined with a connection line between the other end of the housing portion 20 away from the adapter outer shell 32 and the end cap portion 10 to form a symmetrical arc connection line, which further improves the aesthetics.

In some embodiments, all or part of the end portion of the adapter outer shell 32 may protrude toward the adapter inner shell 31 and extend into the first adhesive groove 3112. The adapter outer shell 32 may protrude inward. The protruding may limit the adapter outer shell 32 along the major axis direction and increase the contact area between the end portion of the adapter outer shell 32 and the adhesive, thereby improving the sealing effect.

Referring to FIG. 11, in some embodiments, an end of the inner wall 21 and an end of the outer wall 22 of the housing portion 20 that are close to the adapter outer shell 32 may be provided with the convex portion 27, respectively. The adapter outer shell 32 may be provided with concave portions at inner and outer sides corresponding to the convex portions 27, which can further increase the contact area between the housing portion 20 and the adapter inner shell 31, and improve the sealing of the connection between the housing portion 20 and the adapter inner shell 31.

Referring to FIGS. 6-8, in some embodiments, the end cap portion 10 may be a flexible portion located on a side surface of the earphone. At least a portion of the flexible portion may be disposed at a position that abuts against the cavum conchae wall when the earphone is in the wearing state. This allows the flexible portion to abut against the cavum conchae wall when the earphone is in the wearing state. The flexible portion may be an elastic and soft structure that can elastically deform relative to the cavum conchae wall under a wearing pressure, increasing a contact area with the cavum conchae wall and reducing a pressure of the earphone pressing against the cavum conchae wall, thereby improving the wearing comfort. Furthermore, the elastic deformation of the flexible portion may adapt to different shapes and sizes of cavum conchae of different people, increasing the contact area between the earphone and the cavum conchae wall for different people, and ensuring the wearing comfort. The flexible portion may have a preset length and may not block a clearance between an upper side of the earphone and the external ear canal when the earphone is in the wearing state, and the flexible portion may not block a clearance between a lower side of the earphone and the external ear canal when the earphone is in the wearing state. This ensures that the flexible portion provides the wearing comfort and does not affect the open design of the earphone.

The flexible portion may be located at a position between the outer surface of the inner wall 21 and the outer surface of the outer wall 22. In some embodiments of the present disclosure, the flexible portion may be located on the side surface of the earphone and may be located at the position between the outer surface of the inner wall 21 and the outer surface of the outer wall 22, and an outer surface of the flexible portion may not be coplanar with the outer surface of the inner wall 21 and/or the outer surface of the outer wall 22. In some embodiments of the present disclosure, the outer surface of the flexible portion may not be coplanar with the outer surface of the inner wall 21 and the outer surface of the outer wall 22, and may not protrude from the inner wall 21 or the outer wall 22 of the housing portion 20 in the thickness direction, so as to ensure the aesthetics and overall strength of the earphone.

The flexible portion may not cover the inner wall 21 and outer wall 22 of the housing portion 20, which can avoid the interference of the flexible portion with on the inner wall 21 and outer wall 22, and reserve a larger area on the inner wall 21 and outer wall 22 for setting through holes for sound output or pressure reduction. In addition, the flexible portion may be located at the position between the inner wall 21 and outer wall 22, which does not increase the thickness of the earphone, making the earphone smaller and more beautiful.

The flexible portion may be connected to the housing portion 20, and the outer surface of the flexible portion may form a portion of the side surface of the earphone. The flexible portion may be disposed at a position of the first opening 20b of the housing portion 20, and the flexible portion may cover the first opening 20b and may be connected to the housing portion 20. The flexible portion and the housing portion 20 may be enclosed to form the accommodation cavity 20a within the housing portion 20. By setting the flexible portion as a flexible wall structure of the housing portion 20, the first opening 20b may be disposed on the housing portion 20. The first opening 20b may have a sufficient opening size, and may allow the loudspeaker 50 to be inserted and mounted into the accommodation cavity 20a, which facilitates the mounting of the loudspeaker 50. In some embodiments, the flexible portion may be disposed on the side wall of the housing portion 20, and may cover the side wall of the housing portion 20. When the earphone is in the wearing state, the earphone may abut against the cavum conchae wall through the flexible portion, thereby improving the wearing comfort.

Specifically, the flexible portion may be located at one end of the housing portion 20 in the major axis direction. The flexible portion may be equivalent to a rear wall (the wall facing the rear side of the human body in the wearing state) of the housing portion 20. When the earphone is in the wearing state, the flexible portion abuts against the cavum conchae wall from front to back.

One end of the flexible portion (a lower end in the wearing state) may extend to be aligned with or flush with the lower wall 24 of the housing portion 20, but the flexible portion may not cover the lower wall 24 of the housing portion 20. Since a second clearance space B in communication with the external ear canal is located between a portion of the lower wall 24 of the housing portion 20 close to the flexible portion and the cavum conchae in the wearing state, and the second clearance space B is relatively small, the flexible portion may not extend to cover the lower wall 24 of the housing portion 20, thus avoiding the flexible portion blocking or reducing the second clearance space B. The flexible portion not covering the lower wall 24 of the housing portion 20 ensures both the wearing comfort and sufficient transparency of the open earphone.

In some embodiments, while ensuring that the earphone is in an open state, one end (the lower end in the wearing state) of the flexible portion may extend to the lower wall 24 of the housing portion 20.

The other end (an upper end in the wearing state) of the flexible portion may extend to be aligned with or flush with the upper wall 23 of the housing portion 20. The other end (the upper end in the wearing state) of the flexible portion may extend to form a portion of an upper side surface of the earphone, or may extend to cover a portion of the upper wall 23 of the housing portion 20. The portion of the upper side surface of the earphone refers to a portion of the side surface facing the antihelix in the wearing state. Since a first clearance space A in communication with the external ear canal is located between the upper wall 23 of the housing portion 20 and the cavum conchae in the wearing state, the first clearance space A is relatively large, and a length of the first clearance space A along the major axis direction is greater than that of the second clearance space B, a portion of the flexible portion may extend to the upper wall 23 along the major axis direction without blocking the first clearance space A, and a reduction in the size of the first clearance space A may not affect the transparency of the earphone.

Referring to FIGS. 3-4, in some embodiments, a central axis plane of the flexible portion in the thickness direction may coincide with a central axis plane of the housing portion 20 in the thickness direction. The flexible portion may be aligned with a middle portion of the housing portion 20 in the thickness direction. The flexible portion may be centered relative to the housing portion 20 in a front-back direction, which provides a stronger integrated and improved aesthetics after the flexible portion is connected to the housing portion 20. In some embodiments, the flexible portion may be connected between the outer wall 22 and the inner wall 21, and inner and outer edges of the flexible portion may be aligned and connected with edges of the outer wall 22 and the inner wall 21, respectively. In the wearing state, the flexible portion may not form an additional inward or outward protrusion, which can improve the wearing comfort.

Referring to FIGS. 3-4, in some embodiments, the outer surface of the flexible portion may protrude beyond the outer surface of the housing portion 20. The entire outer surface of the flexible portion may protrude beyond the outer surface of the housing portion 20. When the earphone is in the wearing state, the outer surface of the flexible portion may more easily contact the cavum conchae wall, and the protruding flexible portion may have a larger elastic deformation margin. This prevents the outer surface of the housing portion 20 from contacting the cavum conchae wall after the earphone is squeezed in the wearing state, ensuring that only the elastic and soft flexible portion contacts the body when the earphone is in the wearing state, thereby achieving better wearing comfort. In some embodiments, a portion of the outer surface of the flexible portion may protrude beyond the outer surface of the housing portion 20, which can also prevent the outer surface of the housing portion 20 from contacting the cavum conchae wall when the earphone is in the wearing state, thereby further improving the wearing comfort.

A cross section of the protruding flexible portion in its width direction may be of a semi-circular or elliptical structure. A central portion of the flexible portion with such a semi-circular or elliptical cross section protrudes, and a height of both sides of the protrusion tapers off gradually, extending to connect to the inner wall 21 and the outer wall 22 of the housing portion 20. The raised central portion allows that the flexible portion to be provided with a barrier flexible material to improve the wearing comfort, and the two sides taper smoothly in height to connect with the inner wall 21 and the outer wall 22, resulting in a more aesthetic appearance.

The flexible portion may be a strip or band structure, and the flexible portion may extend along the side surface of the housing portion 20. Specifically, the flexible portion may extend from the rear wall to the upper wall of the housing portion 20. A width of the flexible portion may be equal to or slightly less than a width of the housing portion 20, and the flexible portion may not protrude from the inner wall 21 and outer wall 22 of the housing portion 20.

Referring to FIGS. 6-8, in some embodiments, the flexible portion may only include a first flexible segment 11 and a second flexible segment 12 which are connected. The first flexible segment 11 and the second flexible segment 12 may form an L-shaped or C-shaped structure. The first flexible segment 11 and the second flexible segment 12 may be connected to form two adjacent side walls of the housing portion 20. The first flexible segment 11 may be connected to one end of the housing portion 20 in the major axis direction and may form the rear wall of the housing portion 20. The second flexible segment 12 may be connected to the upper wall 23 of the housing portion 20 in the minor axis direction in the wearing state and may form a portion of the upper wall of the housing portion 20.

The first flexible segment 11 may be configured to abut against the cavum conchae wall. The second flexible segment 12 that extends from the flexible portion may cover one side corner of the earphone. The side corner may abut against the cavum conchae wall. That is, when the earphone is in the wearing state, a portion of the second flexible segment 12 close to the first flexible segment 11 may abut against the cavum conchae wall. The arrangement of the first flexible segment 11 and the second flexible segment 12 allows the first flexible segment 11 and the second flexible segment 12 to completely cover a contact surface between the earphone and the cavum conchae wall in the wearing state, thereby increasing the area of the flexible portion abutting against the cavum conchae wall and thus further improving the wearing comfort.

The second flexible segment 12 may be configured to accommodate and mount electronic components, to expand the functionality of the earphone. For example, an end of the second flexible segment 12 away from the first flexible segment 11 is provided with a mounting cavity 121 and a sound pickup hole 122. The mounting cavity 121 may be a groove provided on an inner wall of the second flexible segment 12. The inner wall is at a side of the second flexible segment 12 facing the housing portion 20. The sound pickup hole 122 may be located between the mounting cavity 121 and an outer wall of the first flexible segment 11. The sound pickup hole 122 may be in communication with the mounting cavity 121 and the outside of the earphone. A first sound pickup device 13 may be disposed in the mounting cavity 121, and a sound pickup portion of the first sound pickup device 13 may be aligned with the sound pickup hole 122, such that the first sound pickup device 13 can collect sound from outside the earphone through the sound pickup hole 122. The sound pickup device 13 may be a microphone (mic) or other sound pickup devices.

The second flexible segment 12 may include a first portion close to the first flexible segment 11 and a second portion away from the first flexible segment 11. The first portion and the second portion may be an integral structure and may not have a physical boundary. One end of the first portion may be close to and connected to the first flexible segment 11, and the other end of the first portion away from the first flexible segment 11 may be connected to the second portion. A portion that abuts against the cavum conchae wall when the earphone is in the wearing state may be defined as the first portion, and a portion that does not abuts against the cavum conchae wall when the earphone is in the wearing state may be defined as the second portion. The mounting cavity 121 and the sound pickup hole 122 may be located in the second portion, such that the sound pickup hole 122 may not be blocked when the earphone is in the wearing state, allowing the first sound pickup device 13 in the mounting cavity 121 to collect sound from the outside of the earphone through the sound pickup hole 122.

In some embodiments, the first flexible segment 11 and the second flexible segment 12 may be an integral structure, and the first flexible segment 11 and the second flexible segment 12 may be integrally molded from a same material. For example, outer surfaces of the first flexible segment 11 and the second flexible segment 12 are integrally molded using a soft material such as silicone by integral injection molding. The first flexible segment 11 and the second flexible segment 12 which are integrally molded have better elastic deformation effect, especially at a turning connection between the first flexible segment 11 and the second flexible segment 12, where there are no clearances, which can ensure the elastic deformation effect at the turning connection and provide better wearing comfort experience.

The first flexible segment 11 and the second flexible segment 12 may be fixedly connected by modes such as bonding or snap-fitting to form a stable structure.

In some embodiments, the second flexible segment 12 may have a preset length. For example, the length of the second flexible segment 12 in the major axis direction does not exceed half the length of the housing portion 20 in the major axis direction. The length of the second flexible segment 12 in the major axis direction may be less than or equal to half the length of the housing portion 20 in the major axis direction. This configuration ensures that the second flexible segment 12 does not obstruct or block the first clearance space A, thus ensuring the transparency of the upper side when the earphone is in the wearing state.

In some embodiments, the flexible portion may include only the first flexible segment 11 and the first portion of the second flexible segment 12, and not include the second portion of the second flexible segment 12. Positions and structures of the first flexible segment 11 and the first portion of the second flexible segment 12 may be the same as in the above embodiments. The first flexible segment 11 and the first portion of the second flexible segment 12 may cover almost an entire contact surface with the cavum conchae wall when the earphone is in the wearing state. When the earphone is in the wearing state, the earphone may abut against the cavum conchae wall through the first flexible segment 11 and the first portion of the second flexible segment 12, thereby ensuring the wearing comfort in the wearing state.

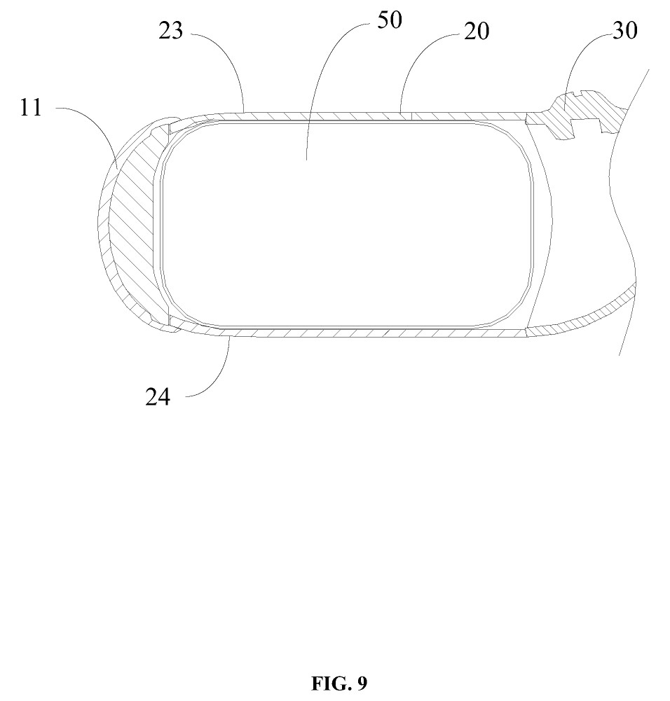

Referring to FIG. 9, in some embodiments, the flexible portion may include only the first flexible segment 11 and not include the second flexible segment 12. The position and structure of the first flexible segment 11 may be the same as in the above embodiments. The first flexible segment 11 may cover most of the contact surface with the cavum conchae wall when the earphone is in the wearing state. That is, when the earphone is in the wearing state, the earphone may abut against the cavum conchae wall mostly through the first flexible segment 11, which improves the wearing comfort in the wearing state.

Referring to FIGS. 6-8. In some embodiments, the flexible portion may be a multi-layer structure. The flexible portion may include at least a contact layer 10a. The contact layer 10a may be an outermost layer of the flexible portion. A Shore hardness of the contact layer 10a may be less than a Shore hardness of the housing portion 20. The contact layer 10a may be made of a material with good softness and elasticity, such as silicone or latex. When the earphone is in the wearing state, the contact layer 10a may contact the cavum conchae wall. The soft contact layer 10a may contact the cavum conchae wall based on surface deformation of the cavum conchae wall, thereby increasing the contact area with the cavum conchae wall and improving the wearing comfort when the earphone is in the wearing state.

The flexible portion may further include an inner liner layer 10b. The inner liner layer 10b may be located on an inner side of the flexible portion. The contact layer 10a may wrap an outer side of the inner liner layer 10b. The Shore hardness of the contact layer 10a may be less than a Shore hardness of the inner liner layer 10b. The inner liner layer 10b may be made of hard materials such as plastic, rubber, or metal. The inner liner layer 10b may be fixedly connected to the housing portion 20 by snap-fitting, bonding, or other modes. The contact layer 10a may be molded or fixed to the outer side of the inner liner layer 10b by injection molding, bonding, or other modes. The flexible portion may include the contact layer 10a and the inner liner layer 10b, to form a double-layer structure that is hard inside and soft outside. The inner liner layer 10b may serve functions of mounting connection and support shaping, while the outer contact layer 10a may provide elastic contact with the human body.

The flexible portion may include a structure composed of more layers or more components. For example, the flexible portion is set as a three-layer structure, where hardnesses of three layers of the three-layer structure decrease in sequence from the inside to the outside, so that the middle layer of the three-layer structure is used as a transition layer between a flexible inner layer and a rigid outer layer, which can improve the wearing comfort and prevent a hardest inner structure from squeezing the human body in the wearing state.

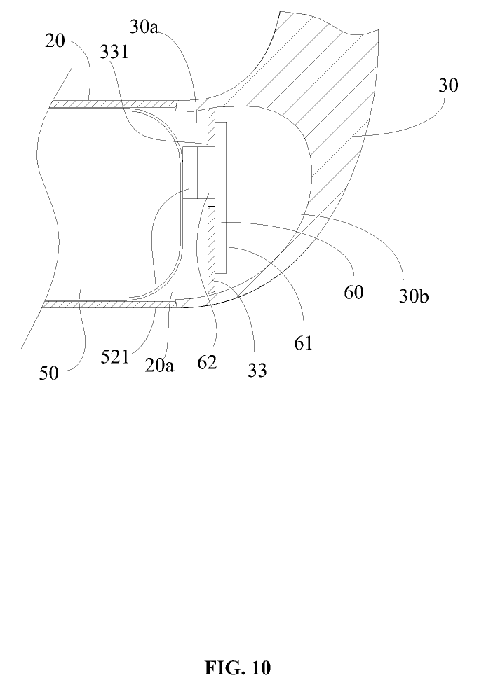

Referring to FIGS. 10-15, in some embodiments, the adapter portion 30 may be provided with two adapter cavities which are independent from each other, and the circuit board assembly 60 may be disposed in one of the adapter cavities of the adapter portion 30.

An accommodation cavity of the adapter portion 30 may be configured to provide the circuit board assembly 60 and other components, thereby optimizing the use of the internal space of the earphone, improving the space utilization of the earphone, and reducing the size of the earphone. Furthermore, the adapter portion 30 may be provided with two adapter cavities which are independent from each other, which can separate the components inside an adapter housing from the loudspeaker 50 inside the housing portion 20, thereby avoiding or reducing electromagnetic interference that components such as the circuit board assembly 60 may cause to the loudspeaker 50. In addition, the independent adapter cavities, with the circuit board assembly 60 provided within the adapter cavity of the adapter portion 30, allow for easier and more convenient sealing, providing better protection for the circuit board assembly 60 and other components within the adapter cavities.

The adapter portion 30 may be provided with two adapter cavities which are independent from each other, which can separate the components inside the adapter housing from the loudspeaker 50 inside the housing portion 20, thereby avoiding or reducing electromagnetic interference that components such as the circuit board assembly 60 may cause to the loudspeaker 50.

Specifically, the adapter portion 30 may be provided with the accommodation cavity, and a separator 33 may be provided inside the accommodation cavity. The separator 33 may be configured to divide the accommodation cavity into a first adapter cavity 30a and a second adapter cavity 30b. The separator 33 may be sealed to an inner wall of the adapter portion 30, such that the first adapter cavity 30a and the second adapter cavity 30b are completely separated and achieve the effect of water prevention.

One end of the adapter portion 30 may be a large end, and the other end of the adapter portion 30 may be a small end. The large end of the adapter portion 30 may be connected to the housing portion 20, and the small end of the adapter portion 30 may be connected to the ear hook portion 40. The first adapter cavity 30a and the second adapter cavity 30b may be distributed in sequence from the large end of the adapter portion 30 to the small end of the adapter portion 30. For example, the first adapter cavity 30a is close to the large end of the adapter portion 30, and the second adapter cavity 30b is away from the large end of the adapter portion 30; that is, the first adapter cavity 30a is located at an end of the adapter portion 30 close to the housing portion 20, and the second adapter cavity 30b is located at the other end of the adapter portion 30 away from the housing portion 20.

The first adapter cavity 30a may be in communication with the accommodation cavity 20a of the housing portion 20. The end of the adapter portion 30 close to the housing portion 20 may be provided with an opening, and the opening of the adapter portion 30 may be in communication with the first adapter cavity 30a. The opening of the adapter portion 30 may be complementary to the second opening 20c of the housing portion 20. After the adapter portion 30 is connected to the housing portion 20, the first adapter cavity 30a and the accommodation cavity 20a may be connected to form a cavity. This arrangement separates the second adapter cavity 30b from the accommodation cavity 20a, allowing components to be provided inside the second adapter cavity 30b, thus separating the components from the loudspeaker 50. Meanwhile, the second adapter cavity 30b may form a sealed cavity, providing waterproof protection for the components within the second adapter cavity 30b.

The first adapter cavity 30a and the second adapter cavity 30b may adopt other arrangements. For example, the first adapter cavity 30a and the second adapter cavity 30b are arranged in a vertically layered manner, where both the first adapter cavity 30a and the second adapter cavity 30b extend from the large end of the adapter portion 30 to the small end of the adapter portion 30. This arrangement facilitates mounting of the components within the first adapter cavity 30a and the second adapter cavity 30b, separates the components within the first adapter cavity 30a and the second adapter cavity 30b, facilitates partial structural sealing, and reduces mutual interference between the components within the first adapter cavity 30a and the second adapter cavity 30b.

In some embodiments of the present disclosure, the circuit board assembly 60 may be mounted in the second adapter cavity 30b, and the circuit board assembly 60 may be electrically connected to the loudspeaker 50. The circuit board assembly 60 and the loudspeaker 50 may be separated by the separator 33, which can reduce mutual electromagnetic interference between the circuit board assembly 60 and the loudspeaker 50. The circuit board assembly 60 may be located inside the sealed second adapter cavity 30b, which can prevent external moisture from entering the second adapter cavity 30b, and can avoid or reduce the risk of damage such as short circuit caused by moisture to the circuit board assembly 60.

To achieve an electrical connection between the circuit board assembly 60 and the loudspeaker 50, the separator 33 may be provided with a mounting hole 331 that penetrates through the separator 33. The circuit board assembly 60 may include a circuit board 61 and a first electrical connection terminal 62. The circuit board 61 may abut against the separator 33, and an area of the circuit board 61 may be greater than an opening area of the mounting hole 331, thus the circuit board 61 covering the mounting hole 331. Viewed from one side of the first adapter cavity 30a, a portion of the circuit board 61 may be exposed through the mounting hole 331. The first electrical connection terminal 62 may be mounted in a region of the circuit board 61 exposed through the mounting hole 331. That is, all or part of the first electrical connection terminal 62 may be located inside the mounting hole 331, i.e., the first electrical connection terminal 62 may be located inside the first adapter cavity 30a. The first electrical connection terminal 62, as a portion of the circuit board assembly 60, may extend into the first adapter cavity 30a to achieve an electrical connection with the loudspeaker 50, while locating a main body of the circuit board assembly 60, i.e., the circuit board 61, within the first adapter cavity 30a. This structure enables electrical connection between the circuit board assembly 60 and the loudspeaker 50, while separating the main body of the circuit board assembly 60 from the loudspeaker 50.

The first electrical connection terminal 62 may be a first plug-in terminal. The loudspeaker 50 may be connected to a flexible circuit board, and one end of the flexible circuit board may be provided with a second electrical connection terminal 521. The second electrical connection terminal 521 may be a second plug-in terminal. One of the first plug-in terminal and the second plug-in terminal may be a socket terminal, and the other of the first plug-in terminal and the second plug-in terminal may be a plug terminal. The first plug-in terminal may be directly fixed to the circuit board 61 by soldering or other modes. The plug terminal and the socket terminal may be plugged in to form the electrical connection. By using the connection mode of the socket terminal and the plug terminal, the electrical connection between the loudspeaker 50 and the circuit board assembly 60 can be quickly completed by plugging in before the housing portion 20 and the adapter portion 30 are connected. This mode is convenient for assembly and facilitates subsequent disassembly and maintenance.

The loudspeaker 50 and the circuit board assembly 60 may be electrically connected in other ways. The first electrical connection terminal 62 may be a flexible circuit board. The first electrical connection terminal 62 may extend into the accommodation cavity 20a to be electrically connected to a body of the loudspeaker 50 or to the flexible circuit board connected to the loudspeaker 50. This mode can achieve the electrical connection between the loudspeaker 50 and the circuit board assembly 60.

In some embodiments, a size of the mounting hole 331 may be adapted to the first electrical connection terminal 62. The first electrical connection terminal 62 may be inserted into the mounting hole 331, allowing the first electrical connection terminal 62 to extend from the second adapter cavity 30b to the first adapter cavity 30a. The first electrical connection terminal 62 may block the mounting hole 331. With this configuration, the mounting hole 331 is blocked using the first electrical connection terminal 62, and the circuit board 61 can be mounted in other positions within the second adapter cavity 30b to meet the arrangement requirements of other components.

In some embodiments, the separator 33 may be a separator plate. The separator 33 may be a plate structure, which can simplify the structure. Meanwhile, two sides of the plate structure may be a plane, respectively. When the circuit board 61 is mounted on a side surface of the separator 33 facing the second adapter cavity 30b, the circuit board 61 may fit the separator 33 in parallel, such that the circuit board 61 may block the mounting hole 331 of the separator 33.

The separator 33 may be an integrally molded separator plate, which can eliminate splicing clearances on the separator plate and improve the sealing and waterproofing effect.

The separator 33 may have other structures. For example, an annular plane is provided around the mounting hole 331 of the separator plate on a side facing the second adapter cavity 30b. The annular plane may be a plane of an annular boss surrounding the mounting hole 331, the surface facing away from a surface of the separator. Alternatively, the annular plane may be a bottom surface of an annular groove recessed around the mounting hole 331. Alternatively, the annular plane may be a plane recessed around the mounting hole 331. Other portions of the separator plate may be planes, inclined surfaces, curved surfaces, or any combination thereof. In this structure, the circuit board 61 may abut against the annular plane surrounding the periphery of the mounting hole 331, which can block the mounting hole 331 to isolate the first adapter cavity 30a from the second adapter cavity 30b.

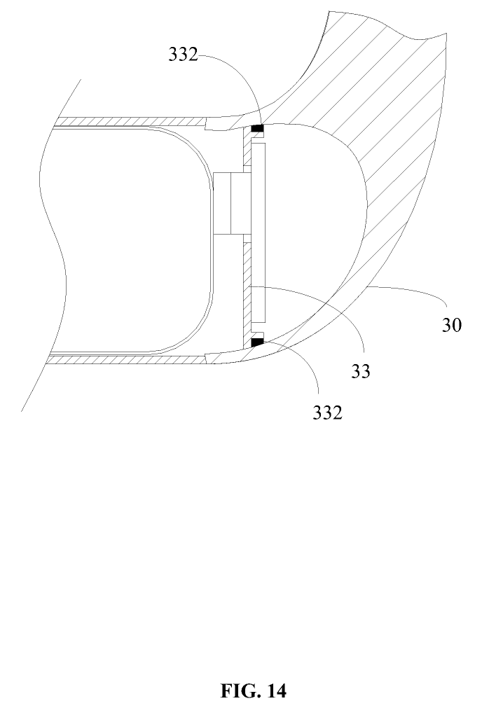

Referring to FIG. 14, four edges of the separator plate may be sealed to the inner wall of the adapter portion 30 to prevent moisture from entering the first adapter cavity 30a or the second adapter cavity 30b from the connection between the separator plate and the inner wall of the adapter portion 30.

The four edges of the separator plate may be provided with a protrusion, or the inner wall of the adapter portion 30 may be provided with a groove. The separator plate and the inner wall of the adapter portion 30 may form a second adhesive groove 332. The second adhesive groove 332 may be filled with an adhesive. The second adhesive groove 332 may be enclosed by the separator plate and the inner wall of the adapter portion 30, allowing the adhesive to contact and connect with both the separator plate and the inner wall of the adapter portion 30, thereby sealing the connection between the separator plate and the inner wall of the adapter portion 30. The second adhesive groove 332 may be located on one side of the second adapter cavity 30b, such that after the separator plate is mounted into the adapter portion 30, the adhesive is isolated within the second adapter cavity 30b by the separator plate. The second adhesive groove 332 and the adhesive do not occupy space in the first adapter cavity 30a, which is beneficial for providing a larger loudspeaker 50. Meanwhile, the adhesive is isolated within the sealed second adapter cavity 30b, which reduces interference from factors such as vibration of the loudspeaker 50, improving the sealing stability of the adhesive. The second adhesive groove 332 and the adhesive may be provided on one side of the first adapter cavity 30a, which can also achieve sealing at the connection between the separator plate and the inner wall of the adapter portion 30.

Other structures or components may be provided between the four edges of the separator plate and the inner wall of the adapter portion 30 for sealing. For example, an annular step is provided in the accommodation cavity inside the adapter portion 30, with the annular step facing an opening of the adapter portion 30, the opening facing the housing portion 20. The separator plate may be mounted into the annular step inside the adapter portion 30, and the four edges of the separator plate may fit the annular step inside the adapter portion 30. With this connection structure, adding the adhesive between the separator plate and the annular step can achieve the sealed connection between the separator plate and the adapter portion 30.

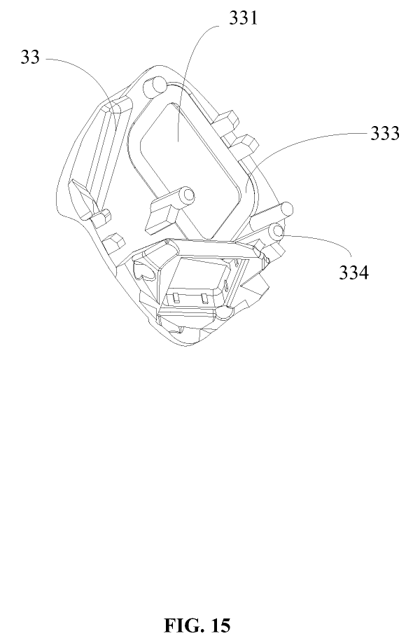

Referring to FIG. 15, in some embodiments, a sealing member 333 may be provided between the separator 33 and the circuit board 61. For example, a side of the separator 33 facing the circuit board 61 is provided with an annular groove that surrounds the mounting hole 331. The sealing member 333 may be disposed in the annular groove. After the circuit board 61 and the separator 33 fit together, the sealing member may form sealing on the mounting hole 331, to separate the mounting hole 331 from the second adapter cavity 30b. The sealing member 333 can further improve the waterproof sealing effect at the mounting hole 331. The annular groove facilitates the mounting and fixation of the sealing member 333, prevents misalignment of the sealing member 333, and improves the waterproof stability of the sealing member 333. In the present disclosure, the sealing member 333 may be an annular adhesive strip or waterproof foam adhesive that fits the annular groove, which can achieve both sealing of the mounting hole 331 and fixation of the circuit board 61 and the separator 33.

The separator 33 may not have an annular groove. The sealing member 333 may be directly disposed between the circuit board 61 and the separator 33, to surround the mounting hole 331, thus achieving sealing for the mounting hole 331. For example, the sealing member 333 is an adhesive, the adhesive is directly applied to the circuit board 61 and/or the separator 33, and after the circuit board 61 and the separator 33 fit together, bonding, fixing, and sealing are achieved.

Referring to FIG. 15, in some embodiments, the separator 33 may serve a function of mounting, or the separator 33 may be understood as a portion of a mounting member. The separator 33 may be configured to separate the first adapter cavity 30a and the second adapter cavity 30b, and the separator 33 may be configured to mount the circuit board 61. This configuration simplifies the structure within the adapter portion 30, and allows the circuit board assembly 60 and the separator 33 to be mounted as a single unit before being mounted into the adapter portion 30 together, optimizing the mounting steps and improving mounting efficiency. Furthermore, the need to mount the circuit board 61 into the adapter portion 30 is eliminated, thereby reducing the mounting difficulty.

An end of the separator 33 facing the second adapter cavity 30b may be provided with a mounting portion 334. The mounting part 334 may be a mounting structure such as a protruding mounting post. The circuit board 61 may be fixedly connected to the mounting portion 334 by screws, snap-fitting, welding, or bonding, or by welding the mounting post, to position and mount the circuit board 61 on the separator 33.

In some embodiments, the adapter portion 30 may be provided with other mounting structures to mount and fix the circuit board assembly 60. For example, the inner wall of the adapter portion 30 is provided with structures such as a protruding mounting post, which can achieve positioning, mounting and fixing of the circuit board 61.

In some embodiments, the circuit board assembly 60 may be disposed in the first adapter cavity 30a. The circuit board assembly 60 and the loudspeaker 50 may be located in the same cavity, which can simplify the connection between the circuit board assembly 60 and the loudspeaker 50. Meanwhile, more space can be freed up to mount other components in the second adapter cavity 30b, thereby achieving the separation and protection of other components.

In some embodiments, the separator 33 may not be provided inside the adapter portion 30. The circuit board 61 of the circuit board assembly 60 may serve as a separator to separate the accommodation cavity into the first adapter cavity 30a and the second adapter cavity 30b. The first electrical connection terminal 62 may be disposed on a side of the circuit board 61 facing the first adapter cavity 30a. Other components may be disposed in the second adapter cavity 30b and electrically connected to the circuit board 61, which can form a relatively independent second adapter cavity 30b, thereby isolating and protecting other components.

In some embodiments, the circuit board assembly 60 may include other components to expand the functionality of the earphone. For example, the earphone further includes a second sound pickup device and a battery circuit. The circuit board 61 may include a first electrical connection portion, a second electrical connection portion, and a third electrical connection portion. The first electrical connection portion may be electrically connected to the first electrical connection terminal 62. The second electrical connection portion may be electrically connected to the second sound pickup device. The third electrical connection portion may be electrically connected to the battery circuit. The first electrical connection portion, the second electrical connection portion, and the third electrical connection portion may be electrically connected to the first electrical connection terminal 62, the second sound pickup device, and the battery circuit, respectively, by soldering, enabling the earphone to have functions such as sound pickup.

The circuit board 61 may be a flexible circuit board. The circuit board 61 may be bent along a curve to be electrically connected to the first electrical connection terminal 62, the second sound pickup device, and the battery circuit which are located in different spatial positions.

The second sound pickup device may be a microphone (mic) or other sound pickup devices. The adapter portion 30 may be provided with a mounting hole that penetrates through the adapter portion 30. The second sound pickup device may be mounted inside a housing with a sound pickup hole. The housing may be fixed within the mounting hole of the adapter portion 30. This arrangement allows the second sound pickup device to be embedded within the housing of the adapter portion 30, reducing the space occupied by the second adapter cavity 30b. The adapter portion 30 may be provided with the sound pickup hole that penetrates through the adapter portion 30. The second sound pickup device may be located inside the adapter portion 30 and aligned with the sound pickup hole, enabling the reception of sound from outside the earphone.

In some embodiments, the circuit board 61 may be a flexible circuit board, and rigid structural plates, such as a steel plate, may be respectively mounted and fixed at weld points of the first electrical connection portion, the second electrical connection portion, and the third electrical connection portion of the circuit board 61. The rigid structural plates can improve the structural stability of the flexible circuit board at the weld points of the first electrical connection portion, the second electrical connection portion, and the third electrical connection portion, thereby ensuring the welding stability at the weld points of the first electrical connection portion, the second electrical connection portion, and the third electrical connection portion.

The above embodiments are employed to illustrate the present disclosure by way of specific examples, which are merely intended to facilitate the understanding of the present disclosure rather than to limit the present disclosure. For those skilled in the art, any simple deductions, modifications or substitutions can be made based on the concept of the present disclosure.

What is claimed is:

1. An earphone, comprising an end cap portion, a housing portion, an adapter portion, an ear hook portion, and a loudspeaker, wherein:
the end cap portion, the housing portion, and the adapter portion are connected in sequence along a major axis direction, the ear hook portion is connected to an end of the adapter portion away from the housing portion, the housing portion is provided with an accommodation cavity, and the loudspeaker is at least partially disposed in the accommodation cavity;
an end of the housing portion along the major axis direction is provided with a first opening in communication with the accommodation cavity, the other end of the housing portion along the major axis direction is provided with a second opening in communication with the accommodation cavity, the end cap portion covers the first opening and is connected to the housing portion, and the adapter portion covers the second opening and is connected to the housing portion; and
the major axis direction is not parallel to a vibration direction of the loudspeaker.

2. The earphone of claim 1, wherein at least one of the first opening or the second opening is configured to allow the loudspeaker to be inserted into the accommodation cavity, and an opening area of the at least one of the first opening or the second opening is greater than a maximum cross-sectional area of the loudspeaker in a cross section taken parallel to the vibration direction of the loudspeaker.

3. The earphone of claim 1, wherein the major axis direction is perpendicular to the vibration direction of the loudspeaker.

4. The earphone of claim 3, wherein the housing portion has a thickness direction perpendicular to the major axis direction, and the vibration direction is parallel to the thickness direction; and
in a wearing state of the earphone, the housing portion includes an inner wall facing an ear, an outer wall away from the ear, an upper wall facing upward, and a lower wall facing downward, the outer wall, the upper wall, the inner wall, and the lower wall are connected in sequence to enclose the accommodation cavity, the inner wall and the outer wall are located on two sides of the housing portion in the thickness direction, respectively, and the vibration direction of the loudspeaker faces the inner wall.

5. The earphone of claim 4, wherein at least the inner wall is provided with a first through hole penetrating through the inner wall, and the first through hole is acoustically connected to the loudspeaker.

6. The earphone of claim 5, wherein the outer wall is provided with a second through hole penetrating through the outer wall.

7. The earphone of claim 1, further comprising a loudspeaker bracket, wherein:
the loudspeaker bracket is disposed in the accommodation cavity, and the loudspeaker is connected to the loudspeaker bracket; and
at least one of the first opening or the second opening is configured to allow the loudspeaker and the loudspeaker bracket to be inserted into the accommodation cavity together.

8. The earphone of claim 7, wherein a first limiting portion is disposed in the accommodation cavity, a second limiting portion is disposed on the loudspeaker bracket, and the first limiting portion and the second limiting portion are adaptively connected to fix the loudspeaker bracket in the accommodation cavity.

9. The earphone of claim 8, wherein the accommodation cavity is provided with a first guide portion extending along the major axis direction, the loudspeaker bracket is provided with a second guide portion, and the first guide portion and the second guide portion are adaptively connected to guide the loudspeaker bracket to be inserted into the accommodation cavity.

10. The earphone of claim 7, further comprising a flexible circuit board, wherein the flexible circuit board is electrically connected to the loudspeaker and fixed to the loudspeaker bracket.

11. The earphone of claim 1, wherein the adapter portion includes an adapter inner shell, an end of the adapter inner shell close to the housing portion includes an insertion portion, and the insertion portion is inserted into the second opening and connected to the housing portion.

12. The earphone of claim 11, wherein the adapter portion further includes an adapter outer shell, the adapter outer shell is configured to enclose an outer side of the adapter inner shell, and the end of the adapter inner shell close to the housing portion protrudes from the adapter outer shell to form the insertion portion.

13. The earphone of claim 11, wherein a third limiting portion is disposed at a position in the housing portion close to the second opening, a fourth limiting portion is disposed on the insertion portion, and the third limiting portion and the fourth limiting portion are adaptively connected to fix the insertion portion in the housing portion.

14. The earphone of claim 12, wherein an outer circumferential side surface of the insertion portion is provided with an adhesive groove, and the adhesive groove is filled with an adhesive material for bonding the housing portion and the insertion portion.

15. The earphone of claim 14, wherein an end surface of the housing portion provided with the second opening is a first inclined surface, and the first inclined surface is inclined relative to a cross section taken parallel to the vibration direction of the loudspeaker; and
an end surface of the adapter outer shell close to the housing portion is a second inclined surface, and the second inclined surface is inclined relative to the cross section taken parallel to the vibration direction of the loudspeaker;
wherein the first inclined surface and the second inclined surface abut against each other.

16. The earphone of claim 15, wherein an end portion of the adapter outer shell provided with the second inclined surface at least partially extends above the adhesive groove.

17. The earphone of claim 16, wherein the end portion of the adapter outer shell extending above the adhesive groove at least partially protrudes toward the adapter inner shell and extends into the adhesive groove.

18. The earphone of claim 14, wherein at least a portion of the housing portion extends toward the adapter portion along the major axis direction to form a convex portion, the adapter outer shell is provided with a concave portion complementary to the convex portion, the insertion portion is provided with an exposed region formed by avoidance of the concave portion, and the adhesive groove is located in the exposed region.

19. The earphone of claim 1, wherein
the housing portion has an integral structure or a split structure made of a metal or plastic material; and/or
the end cap portion includes a contact layer made of a silicone or rubber material, a Shore hardness of the contact layer is less than a Shore hardness of the housing portion, and at least a portion of the contact layer abuts against a cavum conchae wall in a wearing state of the earphone.

20. The earphone of claim 1, wherein the adapter portion and the ear hook portion have an integral structure.
